(19) United States
(12) Patent Application Publication
(10) Pub. No.: US 2026/0172577 A1
(43) Pub. Date: Jun. 18, 2026

(54) METHOD FOR RESILIENT DECODING OF IMAGE SEQUENCES

(71) Applicant: KAKADU R & D PTY LTD, Glebe NSW (AU)

(72) Inventors: David Scott Taubman, Pyrmont NSW (AU); Aous Naman, Ropes Crossing NSW (AU)

(21) Appl. No.: 19/127,245

(22) PCT Filed: Nov. 17, 2023
(86) PCT No.: PCT/AU2023/051174

§ 371 Date: May 5, 2025

(30) Foreign Application Priority Data
Nov. 18, 2022 (AU) 2022903486

(51) Int. Cl. H04N 19/176; H04N 19/119; H04N 19/124; H04N 19/154; H04N 19/172; H04N 19/33; H04N 19/423; H04N 19/63

(52) U.S. Cl. CPC H04N 19/176; H04N 19/119; H04N 19/124; H04N 19/154; H04N 19/172; H04N 19/33; H04N 19/423; H04N 19/63

(57) ABSTRACT

Methods for error resilient decoding of independently encoded video frames are disclosed which do not require a frame buffer to store the most reliable decoded values for each sample location. Instead, the methods described require only the buffering of original encoded code-blocks within a reference buffer. Original encoded blocks of a previous frame are accessed from a reference buffer. These blocks are decoded to retrieve sample values for the block from the previous frame. The decoded sample values from a current block and a corresponding reference block are pardoned into cells having one or one correspondence. The corresponding cells are compared to produce an initial classification label for each cell, the classification label having one of at least 3 values, which identify the cell as ambiguous, consistent or inconsistent. Cells initially labelled as ambiguous or inconsistent are then resolved to consistent using labels assigned to other cells.

### FIELD OF THE INVENTION

This invention relates to image and video decoding. More specifically, it relates to the decoding of a sequence of related encoded images (frames) with non-uniform quality, such the quality of any given spatial region within a frame varies from frame to frame within the sequence. The disclosed method can be applied to video content that has been subjected to a multi-resolution spatial transformation, such as the wavelet transform, together with block-based encoding of the transform sub-bands, as used in JPEG 2000 and several other media encoding algorithms.

### BACKGROUND

When decoding of a sequence of related encoded images (frames) non-uniform quality or quality variation can be encountered. Such quality variation may arise due to the presence of errors in the coded data stream. Quality variations may, however, arise for other reasons such as changes in the communication bandwidth available for communicating the encoded image sequence, or the preferential encoding of regions of interest that change over the sequence. Decoding methods need to accommodate such quality variations.

Error concealment strategies for video coding have been well studied. Typically, the video decoder incorporates one or more frame buffers that hold reference values for each sample in a frame. In traditional predictive video coding algorithms, samples of the current frame have been encoded with respect to the reference values held within frame buffers at the encoder, usually as quantized prediction residuals, where the predicted value of each sample is derived from the frame buffer(s), either directly or through motion compensating or other transformations. In this very common context, the frame buffer(s) used in the encoder are needed also during decoding and so there is little or no additional implementation cost associated with making the values stored in these frame buffer(s) available to an error concealment algorithm that estimates the samples of a current frame when encoded data is erroneous or missing for any reason. The same approach can be used even when video frames are encoded independently, by maintaining frame buffers (usually only one) within the decoder that keep track of recent reliable value for each sample in a frame. In this case, however, frame buffering is used only for error concealment, as opposed to the decoding procedure itself, so it can add significantly to the implementation cost of the decoder.

### Definitions

The term “code-block” here is borrowed from JPEG 2000, as defined in ISO/IEC 15444-1 and other members of the JPEG 2000 family of standards, where a code-block is one independently coded block of samples from one sub-band produced by applying a spatial Discrete Wavelet Transform (DWT) to an image. However, the methods of this invention are applicable also if a code-block is an independently coded collection of samples produced by other transformation methods, or even without transformation of the original frame sample data, and even when the code-block extends over the entire video frame. In particular, the term code-block simply refers to a unit within the coded representation that can potentially be decoded successfully even if another code-block within the same frame is corrupted.

In this disclosure, the term JPEG 2000 is taken to refer to all members of the JPEG 2000 family of standards, and particularly includes both the coding extensions defined in ISO/IEC 15444-2 and the High Throughput JPEG 2000 coding technology defined in ISO/IEC 15444-15.

### SUMMARY OF THE INVENTION

Embodiments of the present invention provide a method for resilient decoding of a sequence of video frames, each having been transformed to produce a plurality of sample blocks, that have been independently encoded, the encoded sample blocks being identified herein as code-blocks, the method involving a reference buffer that is capable of selectively storing previously received code-blocks from the encoded video sequence, where a code-block within a given frame, identified here as the current code-block of the current frame, is processed using the following steps:
a) decoding the current code-block to produce a current block of sample values;
b) obtaining a corresponding reference block of decoded sample values for a previous frame in the video sequence by accessing the reference buffer and performing any required decoding operations to obtain said reference samples;
c) partitioning each of the current and reference blocks of decoded sample values into one or more cells, each cell of the current block being in one to one correspondence with a cell of the reference block;
d) comparing corresponding cells of the current and reference block to produce an initial classification label for each cell pair, the label having at least three possible values that identify the cell as inconsistent, ambiguous or consistent;
e) resolving cell pairs initially labelled as ambiguous to consistent or inconsistent by a label adjustment step that uses the labels assigned to other cells.

In some embodiments, the initial classification label for a cell pair has four possible values that identify the cell as one of: a) inconsistent; b) ambiguous; c) consistent, with a preference for using the reference cell in representations of the current frame; d) and consistent, with a preference for using the current cell in representations of the current frame.

In some embodiments, comparing corresponding cells is based on a comparison of the quantization intervals associated with each sample in the current and reference cell, such that:
a) the cell pair is labelled inconsistent if the quantization interval associated with at least one decoded sample in the current cell is inconsistent with the quantization interval associated with the corresponding sample in the reference cell, where inconsistency here means that the quantization intervals do not intersect;
b) the cell pair is labelled as ambiguous if there are no corresponding sample pairs that are non-zero in both the current and the reference cell; and
c) the cell pair is otherwise assigned a consistent label.

In some embodiments preference for using the reference cell or preference for using the current cell, in representations of the current frame, is determined based on information identifying which of the current and reference cells is more finely quantized.

In some embodiments comparing corresponding cells is based on:
a) a distortion reduction value that assesses the maximum amount by which quantization distortion can be reduced within the more finely quantized of the two cells, over sample locations for which the current and reference quantization intervals are consistent and both current and reference samples are non-zero;
b) a distortion enlargement value that assesses the distortion between the current and reference cells over sample locations for which the current and reference quantization intervals are inconsistent; and
c) an energy value that accumulates an energy statistic, equivalent to distortion between decoded sample values and 0, over all samples of the current and reference cells that are included in the distortion reduction and distortion enlargement value calculations;
where the cell pair is labelled inconsistent if the distortion enlargement term exceeds a specified fraction of the energy value, ambiguous if the energy value is 0; else consistent, where preference for using the reference cell or preference for using the current cell, in representations of the current frame, is determined based on a comparison between the distortion reducing and distortion enlargement values, together with information identifying which of the current and reference cells is more finely quantized.

In some embodiments the code-blocks are independently coded blocks of samples from sub-bands produced by discrete wavelet transformation of the frame sample values.

In some embodiments ambiguity in the classification label assigned to a cell pair is resolved with the aid of temporal inconsistency tracking information, which identifies whether or not any temporal change has been detected over the cell's region of support, in any frame following the one that is associated with the cell's reference code-block, such that the ambiguous label is adjusted to an inconsistent label if such temporal change has been detected.

In some embodiments cells with a similar region of influence in the video frame, identified as co-located cells, are collected in groups and a co-inconsistency step modifies temporal inconsistency tracking information so as to identify temporal change for one cell within a group based on the detection of novel temporal inconsistency in any cell within the same group, where novel temporal inconsistency in a cell means that temporal change is detected for the first time in that cell since the frame associated the cell's reference code-block.

In some embodiments temporal inconsistency tracking is performed by assigning a binary state variable to cells in a frame, where the binary state variable for a cell is set to a prescribed value, its active state, after temporal change is identified, and is reset to the other value, its inactive state, when the reference buffer is updated so that future frames will employ a new reference code-block for the cell.

In some embodiments temporal inconsistency tracking information is performed jointly for all of the co-located cells within a group, using a single state variable that serves to identify the most recent frame in which novel temporal inconsistency has been detected within any cell of the group.

In some embodiments a co-consistency step adjusts the classification label of a cell from ambiguous to consistent, if the temporal inconsistency tracking information for the cell does not identify temporal change since the frame associated with the cell's reference code-block, and another co-located cell in the same group, whose reference code-block comes from the same or an earlier frame, is labelled as consistent.

In some embodiments a cell belonging to a lower resolution sub-band of a frame, whose region of influence in the video frame overlaps that of a cell from a higher resolution sub-band, is identified as an ancestor of the higher resolution cell, and an inter-consistency step adjusts the classification label of the higher resolution cell from ambiguous to consistent, if the temporal inconsistency tracking information for the higher resolution cell does not identify temporal change since the frame associated with that cell's reference code-block, and the ancestor cell's reference code-block comes from the same or an earlier frame and is labelled as consistent.

In some embodiments an inter-inconsistency step adjusts the temporal inconsistency tracking information for the higher resolution cell, so that it identifies temporal change in the higher resolution cell once novel temporal inconsistency has been detected in the ancestor cell.

In some other embodiments an inter-inconsistency step adjusts the temporal inconsistency tracking information for the higher resolution cell, so that it identifies temporal change in the higher resolution cell once novel temporal inconsistency has been detected in an ancestor cell, or in an ancestor of said ancestor cell, but not if the immediate ancestor is ambiguous and a power inversion property is observed, meaning that a measure of the signal power within the higher resolution cell's reference samples is larger than a measure of the signal power within the immediate ancestor's reference samples. In an embodiment this method can be applied to groups of co-located cells, such that a group of co-located cells from higher resolution sub-bands has an identified ancestor group, consisting of the lower resolution ancestor cells of each cell in the higher resolution group, and the measures of signal power used to identify power inversion are calculated over all cells in the higher resolution group and over all cells in the lower resolution ancestor group.

In some embodiments each ambiguous cell classification label remaining ambiguous is adjusted to a non-ambiguous label, where the adjusted label is inconsistent if temporal inconsistency tracking information for the associated cell identifies temporal change, else consistent if a power inversion property has been observed in connection with the cell, else determined using a default policy that specifies either inconsistency or consistency as the default label for all cells that would otherwise remain ambiguous.

In some embodiments the reference buffer is updated based on contextual hints that allow the resilient decoder to determine whether a code-block of the current video frame should be used as a reference code-block for future frames, such contextual hints including protocol information and designated marker codes that accompany the encoded video content received by the decoder.

In some embodiments the reference buffer is updated based on cell classification labels, together with quantization interval length statistics, such that a current code-block that has a sufficient fraction of cells labelled as inconsistent or consistent with a preference for using the current cell in representations of the current frame, is entered into reference buffer to become a reference cell for future frames, where the sufficient fraction itself depends on the quantization interval length statistics.

In some embodiments a video frame is reconstructed from merged cells of the frame, such that a merged cell is derived from the current and reference cells of a cell pair by:
a) using the decoded sample values of the current cell when the final classification label for the cell is inconsistent or when the classification label or quantization interval length statistics identify the current cell as the one that is preferred for representations of the current frame; else
b) using the decoded sample values of the reference cell.

In some embodiments code-blocks from selected high resolution sub-bands are assigned only one cell each and that cell's final classification label is pre-determined based on the classification labels assigned to lower resolution cells, so that only the reference or the current version of each high resolution code-block needs to be decoded, rather than both versions, depending on the pre-determined classification labels, where the high resolution cells are initially assigned ambiguous labels, and the method of claim 12, in combination with the methods of any of claim 13 to claim 16, are used to convert these ambiguous labels to final classification labels that are inconsistent or consistent.

### BRIEF DESCRIPTION OF THE DRAWINGS

An embodiment, incorporating all aspects of the invention, will now be described by way of example only with reference to the accompanying drawings in which

FIG. 1: illustrates an overview of the invention, identifying some of the key concepts, notation and aspects of the invention;

FIG. 2: is an illustration of an example of temporal inconsistency tracking; and

FIG. 3: is an illustration of reference buffer management.

### DETAILED DESCRIPTION

Embodiments of the invention provide methods for error resilient decoding of independently encoded video frames that does not require a frame buffer in the traditional sense, which can be updated from frame to frame with the most reliable decoded values for each sample location. Instead, the methods described in this invention require only the buffering of original encoded code-blocks within a reference buffer.

Embodiments of the method for resilient decoding are applied to a sequence of video frames, where each video frame has been transformed to produce a plurality of sample blocks, that have been independently encoded. The encoded sample blocks are referred to herein as code-blocks. The method involves a reference buffer that is capable of selectively storing previously received code-blocks from the encoded video sequence. A code-block within a given frame, identified here as the current code-block of the current frame, is processed using the following steps:
a) decoding the current code-block to produce a current block of sample values;
b) obtaining a corresponding reference block of decoded sample values for a previous frame in the video sequence by accessing the reference buffer and performing any required decoding operations to obtain said reference samples;
c) partitioning each of the current and reference blocks of decoded sample values into one or more cells, each cell of the current block being in one to one correspondence with a cell of the reference block;
d) comparing corresponding cells of the current and reference block to produce an initial classification label for each cell pair, the label having at least three possible values that identify the cell as inconsistent, ambiguous or consistent;
e) resolving cell pairs initially labelled as ambiguous to consistent or inconsistent by a label adjustment step that uses the labels assigned to other cells.

Original encoded blocks of a previous frame are accessed from a reference buffer. These blocks are decoded to retrieve sample values for the block from the previous frame. The decoded sample values from a current block and a corresponding reference block are partitioned into cells having one or one correspondence between the current and reference frames. The corresponding cells are compared to produce an initial classification label for each cell, the classification label having one of at least 3 values, which identify the cell as ambiguous, consistent or inconsistent. Cells initially labelled as ambiguous or inconsistent are then resolved to consistent using labels assigned to other cells.

The methods described in this disclosure are particularly beneficial when applied to video content whose frames have been encoded independently (also known as intra coding), since then errors or quality fluctuations encountered in one frame need not affect the decoding of other frames in the sequence. Moreover, in this context, the methods described in this invention do not require a frame buffer to keep track of decoded sample values from previous frames, which can be particularly beneficial for lightweight deployments on embedded hardware platforms. More particularly, the methods described in this invention are particularly beneficial when used with block-based encoding techniques that independently encode blocks of samples, either in the image domain or a transform domain such as the wavelet domain, since then errors or quality fluctuations encountered in one block do not necessarily affect the decoding of other blocks within the same frame of the sequence. Finally, the methods described in this disclosure are particularly beneficial when applied to video content that has been subjected to a multi-resolution spatial transformation, such as the wavelet transform, together with block-based encoding of the transform sub-bands, as used in JPEG 2000 and several other media encoding algorithms.

### Overview and Context of the Invention

While error resilience is normally used only to combat unintentional corruption of the encoded media data stream, the same techniques can be used to improve the quality of a video sequence that has been encoded non-uniformly, such that some frames or regions of frames have significantly lower quality than others. In particular, lower quality code-blocks in a current frame can be processed as if they had been corrupted, so long as higher quality reference code-blocks are available from a previous frame. The main difference between non-uniform quality decoding applications and error resilient decoding is that the former introduce more ambiguity concerning the choice of reference code-blocks to keep track of within the reference buffer. This is because the discrimination between corrupted and non-corrupted code-blocks is often trivial in comparison to the discrimination between higher and lower quality versions of a code-block as the video sequence evolves over time. In the case of JPEG 2000, however, error resilient decoding applications can wind up being equivalent to non-uniform quality decoding applications, since JPEG 2000 code-blocks are progressively encoded using an embedded block coding algorithm, such that errors in one code-block bit-stream lead only to quality reductions, as opposed to complete corruption of the decoded sample values.

In some cases, an encoder or content distribution server may intentionally introduce substantial quality variations from code-block to code-block, as a method for reducing communication bandwidth. An excellent example of this is the “JSIV” video communication framework (for example, as described in A. Naman and D. Taubman, “JPEG2000-based scalable interactive video (JSIV),” IEEE Transactions on Image Processing, vol. 20, no. 5, pp. 1435-1449, 2011), in which a server dynamically optimizes the delivery of code-block bit-streams over a bandwidth constrained channel, based on the assumption that a client which receives entirely empty code-blocks (no coded bits at all) will use the most recent non-empty version of the same code-block from a previous frame. That is, JSIV assumes that the decoder has a reference buffer containing the most recent non-empty version of each code-block in a frame and that the decoder addresses the non-uniform quality of each frame by simply replacing empty code-blocks in a current frame with the corresponding code-block bit-stream from the reference buffer. JSIV can also be used with motion compensation (for example as described in A. Naman and D. Taubman, “JPEG2000-based scalable interactive video (JSIV) with motion compensation,” IEEE Transactions on Image Processing, vol. 20, no. 9, pp. 2650-2663, 2011), in which case the use of the reference buffer is more complex, but the principles are basically the same. The methods described in this invention can be used to further enhance the decoded video quality associated with content delivered by a JSIV server.

In its simplest form, JSIV is a “conditional replenishment” scheme, where non-empty code-blocks within the current frame are used to update (or “replenish”) the corresponding sample values, while empty code-blocks retain their previous values (i.e., they are not replenished). In JSIV, the conditional replenishment operates in the wavelet domain, since JPEG 2000 code-blocks partition wavelet sub-bands rather than the image data associated with each video frame. More generally, though, conditional replenishment tools have a very long history of application within video codecs. Since the earliest video coding standards, such as H.261, conditional replenishment has been an important mode for block-based motion compensated video codecs, which can explicitly identify (e.g., through mode flags) blocks that are not updated (not replenished) with new data in a given frame. These video codecs mostly operate with image-domain blocks, e.g., “macro-blocks,” that are subjected to block-based transform, quantization and coding operations. Apart from operating in the image domain, rather than the wavelet domain, the other distinction between conditional replenishment based video codecs and JSIV is that JSIV is an open-loop scheme that does not require the decoder to adopt a prescribed strategy for processing the content that it receives; by contrast, most video codecs employ a closed-loop approach, where the decoder progressively updates at least one frame buffer that is replicated within the encoder. The JSIV server makes rate-distortion optimizing decisions regarding the content that it sends to a remote client, based on an assumption that the decoder will employ a sensible method for reconstructing the non-uniform quality content that it receives, but the decoder has the freedom to use its reference buffer in any manner it sees fit.

As noted, the methods described in this invention can be used to address both error resilient decoding and the decoding of content in which code-blocks may be intentionally dropped from the transmitted video stream to save bandwidth, which can be seen as a form of conditional replenishment. More generally, however, the methods of this invention can be used in the less extreme case where some code-blocks have significantly lower quality than other code-blocks within a given frame, without necessarily being entirely empty or corrupted. A video encoder or distribution server may intentionally create such content, as a method for reducing communication bandwidth while preserving a minimum level of video quality even for non-resilient decoders. The purpose of this invention is to provide robust methods for decoding such content no matter how it has been created, whether by a JSIV-like encoder or server that carefully selects the code-blocks to be sent with higher quality based on temporal changes in the scene, or by a naïve encoder that employs a data independent strategy for cycling through code-blocks that are to be sent with higher quality.

Importantly, all the methods of this invention can be applied using a reference buffer that consists only of original code-blocks from the encoded content that is received by the decoder, without the need to store decoded sample values from a previous frame. This property can be highly beneficial in embedded hardware systems where memory and memory bandwidth are heavily constrained resources. One way to address the memory and memory bandwidth concerns associated with maintaining a frame buffer is to employ lightweight data compression techniques for the frame buffer itself, as described, for example, in US patent application publication no. 2011/0310974, entitled “Frame buffer compression for video processing devices”. However, the reference buffer employed in this invention stores only original code-block bit-streams received by the decoder; no encoding is performed within the decoder to maintain the reference buffer.

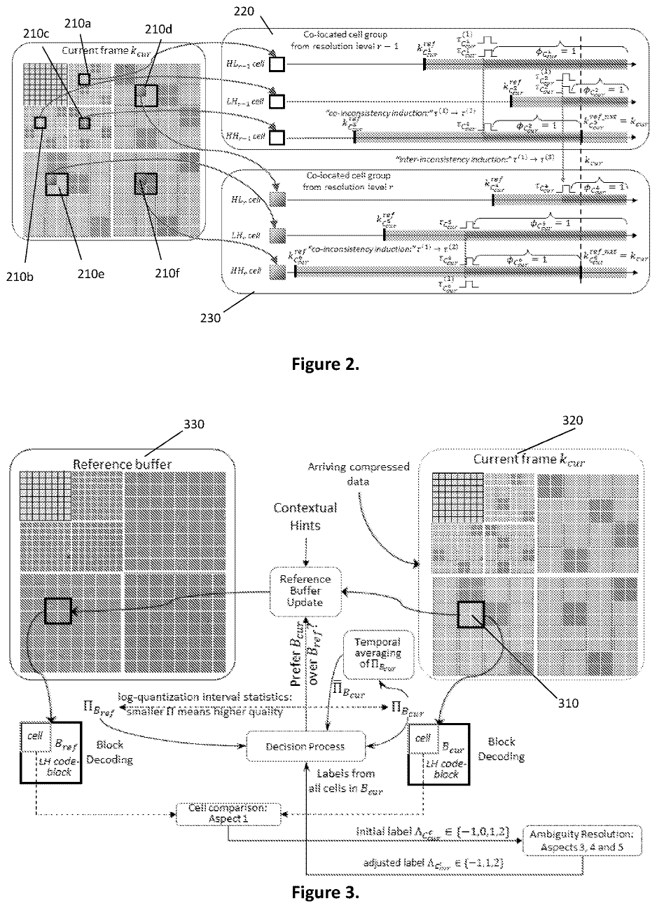

FIG. 2 illustrates an overview of the invention, identifying some of the key concepts, notation and aspects of the invention. In the figure, frames 100 have been independently compressed using a Discrete Wavelet Transform (DWT) whose sub-bands 105 have been partitioned into independently coded code-blocks 110a-n, as is done in JPEG 2000. Arriving data consists of compressed code-blocks 110a-n, while a reference buffer holds previously received code-blocks B_{ref} 120a-n, with various frame indices k^{ref}. Lightly shaded regions in the current (arriving) frame's sub-bands are intended to indicate code-blocks B_{cur} (i.e. 110a, 110c) that have reduced quality (larger Π_{B}_{_{cur}} value), which may happen more often than not in some applications of the invention. Decoded code-blocks 130 are partitioned into cells 135; cells are grouped with co-located cells 135a-c from other sub-bands; cells 135, 155 are compared 160 between current 130 and reference code-blocks 150 to establish an initial set of labels A; ambiguity in the labelling process is resolved with the help of other cell comparisons 170; and a preferred version of each cell (current or reference) 180 is used to reconstruct the final video frame 190.

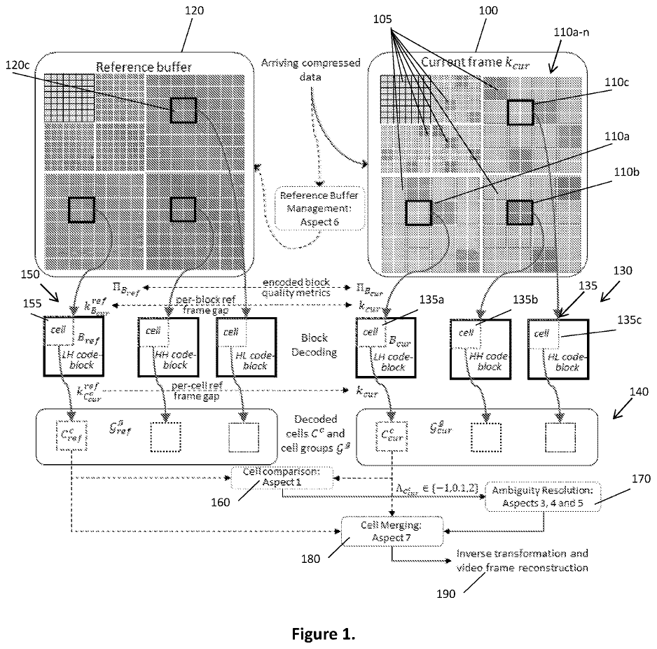

The invention consists of the following aspects, many of which are illustrated in FIG. 1, along with notation that is discussed in more detail in the following sections.

Aspect 1: A method for decoding and comparing a code-block B_{cur} from the current frame and a corresponding code-block B_{ref} from the reference buffer, involving partitioning of the decoded samples from B_{cur} into one or more cells C_{cur} and the assignment of a classification label A to each such cell, based on comparison with a corresponding cell C_{ref} that is derived from B_{ref}. In preferred embodiments, there are four labels Λ∈{−1,0,1,2}, where Λ=−1 identifies inconsistency between C_{ref} and C_{cur}, Λ>0 identifies consistency and Λ=0 means that the comparison is ambiguous. The resolution of such ambiguities is the subject of Aspects 2, 3, 4 and 5 of the invention. The distinction between labels Λ=1 and Λ=2 is that Λ=2 identifies C_{cur} as preferred for use in the current frame's reconstruction, while Λ=1 identifies C_{ref} as the preferred one to use in reconstruction of the current frame. In some embodiments of the invention, there may be no need to distinguish between these two cases of temporal consistency Λ>1 on a cell-by-cell basis, but the distinction is useful for a comprehensive description of the methods of the invention.

Aspect 2: A method for tracking inconsistency across multiple frames of a video sequence, on a cell-by-cell basis, so as to identify novel frames in which inconsistency is first observed within a cell, between the frame from which the cell's reference code-block B_{ref} is derived, and the current frame. This aspect is useful for resolving ambiguous cell classification outcomes Λ=0.

Aspect 3: A method for using cell classification outcomes and temporal inconsistency tracking information for cells belonging to one sub-band to enhance the cell classification outcomes and inconsistency tracking for co-located cells belonging to another sub-band. In some embodiments, this aspect of the invention also allows the temporal inconsistency tracking information associated with co-located cells to be combined so as to reduce the memory footprint associated with tracking state variables.

Aspect 4: A method for using the classification outcomes and temporal inconsistency tracking information from cells belonging to lower resolution code-blocks, to enhance the cell classification outcomes and inconsistency tracking information for cells belonging to higher resolution code-blocks. The method is applicable where the encoded frames have been produced using a multi-resolution transform.

Aspect 5: A method for resolving ambiguous cell classification outcomes Λ=0, using temporal inconsistency tracking information and other contextual information.

Aspect 6: A method for managing the content of the reference buffer, including methods for determining when a reference code-block B_{ref} should be replaced with a corresponding code-block B_{cur} from the current frame; these methods take into account any available information concerning communication errors, the lengths of the bit-streams or number of coding passes associated with B_{ref} and B_{cur}, and explicit information provided within the coded data or a communication protocol that provides hints regarding the relative utilities of B_{ref} and B_{cur}, and (potentially) the cell classification labels deduced via the methods of any of Aspects 1 through 5.

Aspect 7: A method for decoding a video sequence from encoded video frames consisting of code-blocks of non-uniform quality, involving the cell classification and reference buffer management methods of any of Aspect 1 through to Aspect 6, together with a merging procedure that combines the cells from each decoded pair of reference B_{ref} and current B_{cur} code-blocks.

Aspect 8: A method to reduce block decoding resources in applications where the encoded sub-bands come from a multi-resolution transform of each video frame, by pre-determining the final classification label A for code-blocks belonging to one or more of the highest resolutions, using information obtained from lower resolution code-blocks, such that only the current or the reference version of each high-resolution code-block needs to be decoded, but not both.

### DESCRIPTION OF ASPECTS OF THE INVENTION

### 1.1 1^{st} Aspect: Decoding and Comparison of Current and Reference Code-Blocks

The methods of this invention are described in terms of code-blocks, where a current video frame has been (optionally) transformed, producing a collection of sub-bands, then each sub-band has been partitioned into one or more code-blocks that are (optionally) subjected to quantization and coding operations to produce code-block bit-streams, such that the encoded representation of the frame consists of a collection of code-block bit-streams. An important example of interest is JPEG 2000, where the frames have been transformed using a Discrete Wavelet Transform (DWT) prior to any quantization of the wavelet sub-bands and then independent embedded block coding. However, as noted in Section 2, the methods of the invention may be applied with other coding strategies.

### 1.1.1 Sample Values, Quantization Intervals and Related Quantities for a Code-Block B_{cur}

Write k_{cur} for the index (or time) of a current frame within the video sequence and consider any given code-block B_{cur} within that frame, writing Ω_{B}_{_{cur}} for the collection of sub-band sample locations n∈Ω_{B}_{_{cur}} that are spanned by the code-block. Associated with each location n∈Ω_{B}_{_{cur}}, there is a reconstructed sample value y_{B}_{_{cur}}[n] and a quantization interval I_{B}_{_{cur}}[n] that can be obtained by decoding and dequantizing B_{cur}. The quantization interval I_{B}_{_{cur}}[n] is important here; it is the set of all possible sample values X[n] whose quantization is consistent with the encoded representation of B_{cur}. Usually, the reconstructed value y_{B}_{_{cur}}[n] is the mid-point of the interval I_{B}_{_{cur}}[n], but any value within the interval could conceivably be used as the reconstructed value.

In JPEG 2000, the quantization interval I[n] can effectively be embedded implicitly within the reconstructed sample value y[n], by following the mid-point reconstruction rule and recognizing that JPEG 2000 uses a deadzone quantizer, so that y[n] can be expressed as

$$y [ n ] = \frac{Δ}{2} \cdot ( 1 - 2 s [ n ] ) \{ \begin{matrix}{2}^{p [ n ] + 1} μ [ n ] + {2}^{p [ n ]} & if μ [ n ] \neq 0 \\ 0 & if μ [ n ] = 0\end{matrix}$$

Here, Δ is a sub-band wide quantization step size, S_{B}_{_{cur}}[n] ∈{0,1} identifies the sign of the reconstructed sample value, μB_{cur}[n] holds the decoded magnitude bits and p[n] is the number of least significant magnitude bit-planes not encountered within the decoded coding passes associated with sample location n. Then y[n] and its quantization interval I[n] can be fully and compactly described in sign-magnitude form by q[n]≡(s[n],μ̅[n]), where μ̅[n] is the modified magnitude value given by

$$\overline{μ} [ n ] = \{ \begin{matrix}{2}^{p [ n ] + 1} μ [ n ] + {2}^{p [ n ]} & if μ [ n ] \neq 0 \\ {2}^{p [ n ]} & if μ [ n ] = 0\end{matrix}$$

It is a simple matter to recover μ[n] from μ̅[n], by recognizing that whenever μ[n]≠0, μ̅[n] contains at least two non-zero bits, so μ[n]=0 if and only if μ̅[n] is a pure power of 2, which is equivalent to the condition that μ̅[n] and μ̅[n]−1 have a zero logical AND. At the same time, for all values of μ[n], the least significant non-zero bit within μ̅[n] reveals the value of p[n]. Thus, q[n], together with the sub-band wide step size Δ, provides both

$$y [ n ] = \frac{Δ}{2} \cdot ( 1 - 2 s [ n ] ) \{ \begin{matrix}\overline{μ} [ n ] & if ( \overline{μ} [ n ] ∧ ( \overline{μ} [ n ] - 1 ) ) \neq 0 \\ 0 & otherwise\end{matrix}$$

and the p[n], from which we get the length ∥I[n]∥ of the quantization interval as

$$‖ I [ n ] ‖ = Δ \cdot \{ \begin{matrix}{2}^{p [ n ]} & if y [ n ] \neq 0 \\ {2}^{p [ n ] + 1} & otherwise ( the deadzone is twice as large as other intervals )\end{matrix}$$

Since y[n]∈I[n], the values of y[n] and ∥I[n]∥ uniquely determine the quantization interval I[n]. It is useful also to introduce the notation

$$σ [ n ] = \{ \begin{matrix}1 & if μ [ n ] \neq 0 \\ 0 & if μ [ n ] = 0\end{matrix} = \{ \begin{matrix}1 & if ( \overline{μ} [ n ] ∧ ( \overline{μ} [ n ] - 1 ) ) \neq 0 \\ 0 & otherwise\end{matrix}$$

along with the term “significant,” where a sample is said to be significant if σ[n]=1, or equivalently, if y[n]≠0. Finally, we note that the otherwise impossible value q[n]=0 is used for insignificant samples where the quantization interval length ∥I[n]∥ is unknown. This is useful when the code-block B_{cur} is empty, so that no information is available for the decoder. In some embodiments of the invention, the value q[n]=0 is used for all insignificant samples, as a means of simplifying the implementation, even if the quantization interval length ∥I[n]∥ could be deduced by the decoder.

Similar strategies can be applied to quantization schemes other than the JPEG 2000 one discussed above, to describe both the reconstructed sample value and the quantization interval for each sample, via one or more global quantization step sizes and an integer q[n] in sign-magnitude form. For this reason, we use q_{B}_{_{cur}}[n] henceforth to collectively identify both y_{B}_{_{cur}}[n] and I_{B}_{_{cur}}[n] for a sample location n∈Ω_{B}_{_{cur}}.

In addition to q_{B}_{_{cur}}[n], y_{B}_{_{cur}}[n], I_{B}_{_{cur}}[n] and σ_{B}_{_{cur}}[n], which are all sample-specific quantities, let Π_{B}_{_{cur}} be a measure of the average log-quantization interval length, log₂∥I_{B}_{_{cur}}[n], over all n∈Ω_{B}_{_{cur}}. This can be computed as log₂ Δ plus the average of the p_{B}_{_{cur}}[n] values, where p[n] is the number of least significant magnitude bit-planes not encountered within the decoded coding passes associated with sample location n, as explained above. However, in the case of JPEG 2000 code-blocks, it is preferable to estimate a value for Π′_{B}_{_{cur}}=Π_{B}_{_{cur}}−log₂Δ simply by counting the number of finest coding passes that are missing from B_{cur} and dividing by 3.

To be clear, JPEG 2000 code-blocks are extracted from J2K packets, where the packet headers identify the number of coding passes that are present for each block, along with the number of most significant magnitude bit-planes P that are “missing,” in the sense that the first coding pass encodes the next most significant magnitude bit-plane. Moreover, the total number of coding passes that could be present in a code-block, is equal to 3(M_{b}−P)−2, where M_{b} is deduced from the relevant sub-band's quantization parameters, as the maximum number of magnitude bit-planes that can be encoded for any sample. The “number of finest coding passes that are missing” from B_{cur}, mentioned above, is then the difference between the number of actual coding passes available for B_{cur} and this maximum value 3(M_{b}−P)−2. The reason for dividing by 3 is that there are three JPEG 2000 coding passes for each magnitude bit-plane. Other coding technologies may provide their own means for estimating the log-quantization interval within a code-block, based solely on parameters extracted from the code-stream.

### 1.1.2 Sample Values and Related Quantities for a Reference Code-Block B_{ref}

We write q_{B}_{_{ref}}[n], y_{B}_{_{ref}}[n], I_{B}_{_{ref}}[n], σ_{B}_{_{ref}}[n] and Π_{B}_{_{ref}} to identify the same quantities for a reference code-block, whose region of support Ω_{B}_{_{ref}} is the same as Ω_{B}_{_{cur}}, within the same sub-band of an earlier frame

$${k}_{{B}_{c u r}}^{ref} < {k}_{cur}$$

in the video sequence. In preferred embodiments of the invention, these quantities are all obtained by decoding an original code-block B_{ref} that is co-located with B_{cur} within frame

$${k}_{{B}_{c u r}}^{ref} .$$

If there is no such code-block within the reference buffer, for any reason, q_{B}_{_{ref}}[n] is taken to be 0 for all n∈Ω_{B}_{_{cur}}, meaning that all of the code-block's samples are taken to be insignificant and with unknown (unbounded) quantization interval length ∥I_{B}_{_{ref}}[n]∥, as explained above. In many embodiments of the invention, reference code-blocks B_{ref} are used only if they were encoded using the same underlying sub-band wide quantization step size Δ as B_{cur}, again setting q_{B}_{_{ref}}[n]=0 if this is not the case. This limitation is reasonable, especially for JPEG 2000 based deployments, since the underlying quantization step sizes do not normally change from frame to frame when JPEG 2000 is used as the codec—the encoded data rate is usually controlled separately through the number of coding passes that are emitted to the output codestream. In this important case, where A does not change over time, it is sufficient to calculate

$${\prod }_{{B}_{cur}}^{′} = {\prod }_{{B}_{cur}} - {log}_{2} Δ and {\prod }_{{B}_{ref}}^{′} = {\prod }_{{B}_{ref}} - {log}_{2} Δ$$

rather than Π_{B}_{_{cur}} and Π_{B}_{_{ref}}, noting that

$${\prod }_{{B}_{cur}}^{′} and {\prod }_{{B}_{ref}}^{′}$$

can be estimated by counting the number of finest coding passes that are missing from B_{cur} and B_{ref}, respectively, and dividing by 3.

In some embodiments of the invention, the reference buffer may consist of decoded sample data instead of code-block bit-streams, in which case q_{B}_{_{ref}}[n] and Π_{B}_{_{ref}} can be recovered directly from the reference buffer, without requiring these quantities to arise from a unique code-block B_{ref} within the earlier frame; indeed q_{B}_{_{ref}}[n] and thence Π_{B}_{_{ref}} may even be derived using a motion compensation procedure in some embodiments of the invention. Nevertheless, preferred embodiments of the invention avoid the need to buffer actual decoded sample data by buffering reference code-block bit-streams instead, decoding any available B_{ref} concurrently with B_{cur}.

11.3 Partition of Code-Blocks into Cells

In this invention, the code-block region Ω_{B}_{_{cur}} is partitioned into one or more cells,

$${C}_{cur}^{c} ,$$

each with their own region of support

$${Ω}_{{C}_{cur}^{c}} ,$$

such that

$${Ω}_{{B}_{cur}} = {⋃}_{c ∈ {𝒫}_{{B}_{cur}}} {Ω}_{{C}_{cur}^{c}} ,$$

where [symbol] _{B}_{_{cur}} denotes the set of cell indices c that belong to code-block B_{cur}. In preferred embodiments of the invention, cells are 4×4 square blocks, but other cell dimensions may be preferred for some applications and indeed a single cell can span the entire code-block if desired. As a matter of convenience we write

$${q}_{{C}_{cur}^{c}} [ n ] = {q}_{{B}_{cur}} [ n ]$$

for the decoded sample values and quantization intervals of cell c∈ [symbol] B_{cur}, for each

$$n ∈ {Ω}_{{C}_{cur}^{c}} .$$

Similarly, we write

$${q}_{{C}_{ref}^{c}} [ n ] = {q}_{{B}_{ref}} [ n ]$$

for each

$$n ∈ {Ω}_{{C}_{cur}^{c}} ,$$

we write

$${k}_{{C}_{cur}^{c}}^{ref} = {k}_{{B}_{cur}^{c}}^{ref}$$

for the frame to which the reference code-block B_{ref} usedd with B_{cur} belongs, and we write

$${\prod }_{{C}_{cur}^{c}} = {\prod }_{{B}_{cur}} and {\prod }_{{C}_{ref}^{c}} = {\prod }_{{B}_{ref}} ,$$

for all c in the cell partition [symbol] _{B}_{_{cur}} of B_{cur}.

$${C}_{cur}^{c} and {C}_{ref}^{c}$$

form a “cell pair,” while for each

$$n ∈ {Ω}_{{C}_{cur}^{c}} , {q}_{{C}_{cur}^{c}} [ n ] and {q}_{{C}_{ref}^{c}} [ n ]$$

describe a pair of decoded sample values, along with their quantization intervals. A significant step in the invention is to compare the cells of a cell pair, which in turn involves the comparison of samples and quantization intervals of sample pairs. The purpose of cell comparison is to determine a classification label

$${Λ}_{{C}_{cur}^{c}} ∈ \{ - 1 , 0 , 1 , 2 \}$$

for the cell pair. In this description of the invention, the term “cell pair” is often rep aced simply by “cell”, where the involvement of a pair of cells

$${C}_{cur}^{c} and {C}_{ref}^{c}$$

is obvious from the context. Also, the label

$${Λ}_{{C}_{c u r}^{c}}$$

expicitly identifies only the cell

$${C}_{cur}^{c} ,$$

even though the label is derived from both

$${C}_{cur}^{c} and {C}_{ref}^{c} ,$$

and the same is true for the notation used for other quantities in this description of the invention.

As noted already, the classification labels of interest are: Λ=−1 (inconsistent); Λ=0 (ambiguous); Λ=1 (consistent, with a preference to reconstruct using

$${C}_{ref}^{c} )$$

and Λ=2 (consistent, with a preference to reconstruct using

$${C}_{cur}^{c} ) .$$

There are multiple ways to do determine the label for each cell pair, depending in part upon the type of encoded video content that the decoder is expected to process. In order to explain these different labelling strategies, we first introduce the binary symbol

$${ϵ}_{{C}_{cur}^{c}} [ n ] ,$$

to indicate whether or not

$${q}_{{C}_{cur}^{c}} [ n ] and {q}_{{C}_{ref}^{c}} [ n ]$$

describe a sample pair with incompatible quantization intervals. Specifically,

$${ϵ}_{{C}_{cur}^{c}} [ n ] = \{ \begin{matrix}1 & if {I}_{{C}_{cur}^{c}} [ n ] ⋂ {I}_{{C}_{ref}^{c}} [ n ] = \\ & ∅ ( non - intersecting intervals are incompatible ) \\ 0 & otherwise ( intersecting intervals are considered compatible )\end{matrix}$$

In the common case where frames

$${k}_{cur} and {k}_{{C}_{ref}^{c}}$$

use the same underlying set of sub-band wide quantization step sizes Δ

$${ϵ}_{{C}_{cur}^{c}} [ n ]$$

can be deduced directly from the value of

$${q}_{{C}_{c u r}^{c}} [ n ] and {q}_{{C}_{r e f}^{c}} [ n ]$$

alone. Also, if either of

$${q}_{{C}_{c u r}^{c}} [ n ] or {q}_{{C}_{r e f}^{c}} [ n ]$$

is 0, then the corresponding quantization interval is unknown and taken to have unbounded size, so that

$${ϵ}_{{C}_{cur}^{c}} [ n ] = 0 ;$$

that is, an unbounded deadzone in one frame is taken to be compatible with any reconstructed value in the other frame.

### 1.1.4 Cel Classification Label Generation for Screen Content Decoding

Screen content is special in that large regions of the image often remain entirely unchanged across many frames, so that any detectable change between frames can be taken as an indication of inconsistency. When a decoder expects to be processing screen content video sequences, cell

$${C}_{cur}^{c}$$

can be identified as: a) inconsistent

$$\{ Λ = - 1 ) if {ϵ}_{{C}_{c u r}^{c}} [ n ] = 1$$

for any

$$n ∈ {Ω}_{{C}_{cur}^{c}} ; b )$$

ambiguous

$$( Λ = 0 ) if {ϵ}_{{C}_{cur}^{c}} [ n ] = 0$$

$$but {σ}_{{C}_{cur}^{c}} [ n ] = 0 or$$

$${σ}_{{C}_{ref}^{c}} [ n ] = 0 for all n ∈ {Ω}_{{C}_{cur}^{c}} ;$$

and otherwise consistent (Λ>0). For consistent cells,

$$Λ = 2 ( prefer {C}_{cur}^{c} )$$

applies if the quantization intervals of

$${C}_{cur}^{c}$$

are no larger than those of

$${C}_{ref}^{c} ;$$

here, this condition is expressed using the binary value

$${F}_{{C}_{cur}^{c}} = \{ \begin{matrix}1 & if {\prod }_{{C}_{cur}^{c}} \leq {\prod }_{{C}_{ref}^{c}} \\ 0 & otherwise\end{matrix} \qquad ( 1 )$$

If both code-blocks use the same quantization step size Δ, then

$${F}_{{C}_{cur}^{c}} = 1$$

if and only if

$${\prod }_{{C}_{cur}^{c}}^{′} \leq {\prod }_{{C}_{ref}^{c}}^{′} ,$$

which is true if and only if the last coding pass in B_{ref} is also present within B_{cur}. In the case where no reference code-block B_{ref} is available, or in embodiments of the invention where a reference code-block cannot be used because the embodiment requires B_{ref} to have the same quantization step size Δ as

$${B}_{cur} , {\prod }_{{C}_{ref}^{c}} = {\prod }_{{B}_{ref}}$$

can be understood as unbounded (or ∞) and so

$${F}_{{C}_{cur}^{c}}$$

is certainly 1.

In summary, the cell classification labels for screen content decoding are set as follows:

$${Λ}_{{C}_{cur}^{c}} = \{ \begin{matrix}- 1 & if {ϵ}_{{C}_{cur}^{c}} [ n ] = 1 for any n ∈ {Ω}_{{C}_{cur}^{c}} , else \\ 0 & if {σ}_{{C}_{cur}^{c}} [ n ] \cdot {σ}_{{C}_{ref}^{c}} [ n ] = 0 for all n ∈ {Ω}_{{C}_{cur}^{c}} , else \\ 1 + {F}_{{C}_{cur}^{c}} & otherwise\end{matrix} \qquad ( 2 )$$

It is worth noting that since

$${F}_{{C}_{cur}^{c}}$$

can usually be expected to take the same value for all cells in a code-block, there is no need to explicitly distinguish between Λ=1 and Λ=2 at the level of individual cells.

### 1.5 Cel Classification Label Generation for Photographic Video Decoding

For photographic content, small inconsistencies between reconstructed quantization intervals for cells

$${C}_{cur}^{c} and {C}_{ref}^{c}$$

necessarily be interpreted as evidence of significant temporal change, since photographic image sensors are subject to photon shot noise and other minor environmental factors that may occasionally lead to the appearance of inconsistent intervals, even if there is no structural change in the scene content over time. One way to identify temporal change is by applying a correlation technique to the reconstructed sample values

$${y}_{{C}_{cur}^{c}} [ n ] and {y}_{{C}_{ref}^{c}} [ n ]$$

over

$$n ∈ {Ω}_{{C}_{cur}^{c}}$$

and comparing the result against a pre-determined threshold. For example, the label Λ=−1 could be assigned to the case in which the normalized cross correlation between

$${y}_{{C}_{cur}^{c}} and {y}_{{C}_{ref}^{c}}$$

is less than 0.7. It is preferable, however, to first exclude all locations n, for which

$${ϵ}_{{C}_{cur}^{c}} [ n ] and {σ}_{{C}_{cur}^{c}} [ n ] \cdot {σ}_{{C}_{ref}^{c}} [ n ]$$

are both 0. These are the locations for which one or both of

$${y}_{{C}_{cur}^{c}} [ n ] and {y}_{{C}_{ref}^{c}} [ n ]$$

are insignificant yet have compatible quantization intervals, which yield no significant information regarding the temporal consistency between

$${C}_{ref}^{c} and {C}_{cur}^{c} .$$

From an implementation perspective at least, it is preferable to replace normalized correlation metrics with estimates of the relative distortion reduction associated with using

$${C}_{ref}^{c}$$

instead of

$${C}_{cur}^{c}$$

or vice-versa, whichever offers the smaller quantisation intervals. Specifically, preferred embodiments evaluate the following cell-wide quantities:

$${D}_{{C}_{cur}^{c}}^{+} = {\sum }_{\begin{matrix}n ∈ {Ω}_{{C}_{cur}^{c}} , such that \\ {ϵ}_{{C}_{cur}^{c}} [ n ] = 0 and \\ {σ}_{{C}_{cur}^{c}} [ n ] \cdot {σ}_{{C}_{ref}^{c}} [ n ] \neq 0\end{matrix}} {( {y}_{{C}_{cur}^{c}} [ n ] - {y}_{{C}_{ref}^{c}} [ n ] )}^{2} \qquad ( 3 )$$

$${D}_{{C}_{cur}^{c}}^{-} = {\sum }_{\begin{matrix}n ∈ {Ω}_{{C}_{cur}^{c}} , such that \\ {ϵ}_{{C}_{cur}^{c}} [ n ] = 1\end{matrix}} {( {y}_{{C}_{cur}^{c}} [ n ] - {y}_{{C}_{ref}^{c}} [ n ] )}^{2}$$

$$and$$

$${P}_{{C}_{cur}^{c}} = {\sum }_{{{n ∈ {Ω}_{{C}_{cur}^{c}} , such that}_{{ϵ}_{{C}_{cur}^{c}} [ n ] = 1 or}}_{{σ}_{{C}_{cur}^{c}} [ n ] \cdot {σ}_{{C}_{ref}^{c}} [ n ] \neq 0}} {( {y}_{{C}_{cur}^{c}} [ n ] )}^{2} + {( {y}_{{C}_{ref}^{c}} [ n ] )}^{2}$$

Here,

$${D}_{{C}_{c u r}^{c}}^{+}$$

collects the distortion reductions that can be expected from using the more finely quantized representation in place of the coarser representation, taken over all compatible quantization intervals where both samples are significant; the expression effectively treats the more finely quantized values as though they were equal to the original uncompressed samples. Conversely,

$${D}_{{C}_{c u r}^{c}}^{-}$$

collects the distortion associated with incompatible quantization intervals, where using the more finely quantized cell as a substitute for the more coarsely quantized cell can be expected to increase distortion; the expression in this case effectively treats the more quantized value as the best available estimate for the original uncompressed sample value within each inconsistent interval. Notice that compatible insignificant samples are considered to offer no useful insight into the question of temporal consistency, as discussed above. If all samples in the cell have this property,

$${P}_{{C}_{c u r}^{c}} , {D}_{{C}_{c u r}^{c}}^{+} and {D}_{{C}_{cur}^{c}}^{-}$$

are all zero, and the cell comparison is ambiguous.

Notice also that

$${P}_{{C}_{c u r}^{c}} - {D}_{{C}_{c u r}^{c}}^{+} - {D}_{{C}_{cur}^{c}}^{-}$$

is actually twice the correlation of

$${y}_{{C}_{c u r}^{c}} [ n ]$$

with

$${y}_{{C}_{c u r}^{c}} [ n ] ,$$

which exposes an opportunity to potentially simplify the computation of these quantities. Specifically, it can be somewhat simpler to compute from

$${D}_{{C}_{c u r}^{c}}^{+} = {P}_{{C}_{c u r}^{c}}^{+} - 2 {R}_{{C}_{c u r}^{c}}^{+} , {D}_{{C}_{cur}^{c}}^{-} = {P}_{{C}_{c u r}^{c}}^{-} - 2 {R}_{{C}_{c u r}^{c}}^{-} and {P}_{{C}_{c u r}^{c}} = {P}_{{C}_{c u r}^{c}}^{+} + {P}_{{C}_{c u r}^{c}}^{-} ,$$

$${R}_{{C}_{cur}^{c}}^{+} = {\sum }_{\begin{matrix}n ∈ {Ω}_{{C}_{cur}^{c}} , such that \\ {ϵ}_{{C}_{cur}^{c}} [ n ] = 0 and \\ {σ}_{{C}_{cur}^{c}} [ n ] \cdot {σ}_{{C}_{ref}^{c}} [ n ] \neq 0\end{matrix}} {y}_{{C}_{cur}^{c}} [ n ] {y}_{{C}_{ref}^{c}} [ n ] ,$$

$${R}_{{C}_{cur}^{c}}^{-} = {\sum }_{\begin{matrix}n ∈ {Ω}_{{C}_{cur}^{c}} , such that \\ {ϵ}_{{C}_{cur}^{c}} [ n ] = 1\end{matrix}} {y}_{{C}_{cur}^{c}} [ n ] {y}_{{C}_{ref}^{c}} [ n ] ,$$

$${P}_{{C}_{cur}^{c}}^{+} = {\sum }_{\begin{matrix}n ∈ {Ω}_{{C}_{cur}^{c}} , such that \\ {ϵ}_{{C}_{cur}^{c}} [ n ] = 0 and \\ {σ}_{{C}_{cur}^{c}} [ n ] \cdot {σ}_{{C}_{ref}^{c}} [ n ] \neq 0\end{matrix}} {( {y}_{{C}_{cur}^{c}} [ n ] )}^{2} + {( {y}_{{C}_{ref}^{c}} [ n ] )}^{2} and$$

$${P}_{{C}_{cur}^{c}}^{-} = {\sum }_{\begin{matrix}n ∈ {Ω}_{{C}_{cur}^{c}} , such that \\ {ϵ}_{{C}_{cur}^{c}} [ n ] = 1\end{matrix}} {( {y}_{{C}_{cur}^{c}} [ n ] )}^{2} + {( {y}_{{C}_{ref}^{c}} [ n ] )}^{2} .$$

The cell classification label

$${Λ}_{{C}_{cur}^{c}}$$

for photographic video content is formed as follows:

$${Λ}_{{C}_{cur}^{c}} = \{ \begin{matrix}- 1 & if ( {P}_{{C}_{cur}^{c}} - {D}_{{C}_{cur}^{c}}^{-} ) < T \cdot {P}_{{C}_{cur}^{c}} , else \\ 0 & if {P}_{{C}_{cur}^{c}} = 0 , else \\ 2 & if {D}_{{C}_{cur}^{c}}^{-} \geq {D}_{{C}_{cur}^{c}}^{+} or {F}_{{C}_{cur}^{c}} = 1 , else \\ 1 & otherwise\end{matrix} \qquad ( 4 )$$

Here, 0<T<1 is a threshold value, such as 0.9, for example.

Note that when code-blocks B_{cur} and B_{ref} both involve the same quantization step size Δ, as may be required by many embodiments, the common factor Δ² can be eliminated from the calculation of

$${D}_{{C}_{c u r}^{c}}^{+} , {D}_{{C}_{c u r}^{c}}^{-} and {P}_{{C}_{c u r}^{c}} ,$$

since these quantities are only compared with each other or with zero.

It should be apparent to a reader skilled in the art, that there are many variations of the method described here that could be expected to have similar properties. For example, the squaring operations involved in the calculation of

$${D}_{{C}_{cur}^{c}}^{+} , {D}_{{C}_{cur}^{c}}^{-} and {P}_{{C}_{cur}^{c} ,}$$

could all potentially be replaced by absolute values in order to reduce numerical complexity.

### 1.2 2^{nd} Aspect: Temporal Inconsistency Tracking

The purpose of inconsistency tracking is to keep track of temporal change over the region of support of cell

$${C}_{cur}^{c}$$

since the reference for cell

$${C}_{cur}^{c}$$

was last updated—i.e., over frames k in the range

$${k}_{{C}_{cur}^{c}}^{ref} < k \leq {k}_{cur} .$$

The information of relevance is identified by two binary quantities

$${ϕ}_{{C}_{cur}^{c}} ∈ \{ 0 , 1 \} and {τ}_{{C}_{cur}^{c}} ∈ \{ 0 , 1 \} ,$$

where

$${ϕ}_{{C}_{cur}^{c}} = 1$$

means that inconsistency has been observed within a previous frame k since the reference for cell

$${C}_{cur}^{c}$$

was last updated, i.e.,

$${k}_{{C}_{cur}^{c}}^{ref} < k < {k}_{cur} ,$$

while

$${τ}_{{C}_{cur}^{c}} = 1$$

identifies a novel temporal inconsistency observation within the current frame k_{cur}, so that

$${ϕ}_{{C}_{cur}^{c}}$$

will be 1 in the next frame, unless the reference for cell

$${C}_{cur}^{c}$$

is updated.

$${τ}_{{C}_{cur}^{c}}$$

can be interpreted as an “inconsistency trigger” signal, which is actually formed from the inclusive OR of one or more inconsistency trigger signals

$${τ}_{{C}_{cur}^{c}}^{( 1 )} , {τ}_{{C}_{cur}^{c}}^{( 2 )} , … ,$$

that can be produced by various methods of the invention. That is,

$${τ}_{{C}_{cur}^{c}} = \{ \begin{matrix}1 & if any {τ}_{{C}_{cur}^{c}}^{( 1 )} , {τ}_{{C}_{cur}^{c}}^{( 2 )} , … is 1 \\ 0 & otherwise\end{matrix} .$$

The first of these trigger signals is given by

$${τ}_{{C}_{cur}^{c}}^{( 1 )} = \{ \begin{matrix}1 & if {ϕ}_{{C}_{cur}^{c}} = 0 and {Λ}_{{C}_{cur}^{c}} = - 1 \\ 0 & otherwise\end{matrix}$$

so that

$${τ}_{{C}_{c u r}^{c}}^{( 1 )} = 1$$

identifies the frame as one in which cell

$${C}_{c u r}^{c}$$

is inconsistent with its reference

$${C}_{ref}^{c} ,$$

where the inconsistency has not previously been observed, at least since the reference code-block associated with

$${C}_{c u r}^{c}$$

was last updated. In this sense,

$${τ}_{{C}_{c u r}^{c}}^{( 1 )} = 1$$

does indeed represent a novel inconsistency observation in the current frame. Novelty is the key property that allows temporal inconsistency in one cell to be used to infer inconsistency in other cells, given that the cells can have very different reference frames

$${k}_{{C}_{c u r}^{c}}^{ref} .$$

FIG. 2 illustrates some of the temporal inconsistency tracking concepts and notation used here and in later aspects of the invention. The figure shows how novel inconsistency triggers

$${τ}_{{C}_{c u r}^{c}}^{( 1 )}$$

and induced and inconsistency triggers

$${τ}_{{C}_{c u r}^{c}}^{( 2 )} and {τ}_{{C}_{c u r}^{c}}^{( 3 )}$$

from the 3^{rd} and 4^{th} aspects of the invention yield values for

$${τ}_{{C}_{c u r}^{c} and} {ϕ}_{{C}_{c u r}^{c}} ,$$

depending on each cell's reference frame

$${k}_{{C}_{c u r}^{c}}^{ref} .$$

FIG. 3 is an illustration of temporal inconsistency tracking for 6 cells 210a-f, which form two cell groups 220, 230 in accordance with the 3^{rd} aspect of the invention, showing “co-inconsistency induction” within cell groups, and “inter-inconsistency induction” (Aspect 4 of the invention) between cell groups of different resolutions. Cell indices c=1, 2, 3, 4, 5, 6 are used for simplicity here and

$${k}_{{C}_{c u r}^{c}}^{ref \_ nxt} = {k}_{cur}$$

identifies the selection of the next reference frame for cell

$${C}_{c u r}^{c}$$

as the current frame k_{cur}, when

$${C}_{c u r}^{c}$$

comes from a high quality code-block that is entered into the reference buffer, as explained in Aspect 6 of the invention.

A simple method for constructing

$${ϕ}_{{C}_{c u r}^{c}}$$

within the resilient decoder is to maintain a persistent binary state variable (a 1-bit memory) for each cell of a frame, such that

$${ϕ}_{{C}_{c u r}^{c}}$$

is the value of this state variable. The binary state variable whose value is

$${ϕ}_{{C}_{cur}^{c}}$$

is initialized to 0 prior to any processing by the resilient decoder. Once all processing for cell

$${C}_{cur}^{c}$$

is complete within a current frame, the binary state variable is updated according to

$${ϕ}_{{C}_{cur}^{c}} ← \{ \begin{matrix}0 & if {k}_{{C}_{cur}^{c}}^{ref \_ nxt} \neq {k}_{{C}_{cur}^{c}}^{ref} \\ {ϕ}_{{C}_{cur}^{c}} V {τ}_{{C}_{cur}^{c}} & otherwise\end{matrix} = \{ \begin{matrix}0 & if {k}_{{C}_{cur}^{c}}^{ref \_ nxt} \neq {k}_{{C}_{cur}^{c}}^{ref} \\ 1 & if any {τ}_{{C}_{cur}^{c}}^{( 1 )} , {τ}_{{C}_{cur}^{c}}^{( 2 )} , … is 1 , \\ {ϕ}_{{C}_{cur}^{c}} & otherwise\end{matrix}$$

where

$${k}_{{C}_{cur}^{c}}^{ref \_ nxt} \neq {k}_{{C}_{cur}^{c}}^{ref}$$

means that the reference code-block B_{ref} associated with cell

$${C}_{cur}^{c}$$

is being updated within the reference buffer, as described in Section 3.6.

Another method for constructing

$${ϕ}_{{C}_{cur}^{c}}$$

is described in Section 3.3, which can be more efficient in terms of the memory required to maintain temporal inconsistency state information.

In some embodiments of the invention, cells that are initially assigned an ambiguous label

$${Λ}_{{C}_{cur}^{c}} = 0$$

by the methods described in Section 3.1 have their label reassigned immediately to

$${Λ}_{{C}_{cur}^{c}} = - 1$$

(inconsistent) if

$${ϕ}_{{C}_{cur}^{c}} = 1 or {τ}_{{C}_{cur}^{c}} = 1.$$

However, preferred embodiments of the invention defer such reassignment until after the methods described in Section 3.4 have been applied; this allows for additional conditions to be imposed on the propagation of temporal inconsistency across resolution levels. Aspect 5 of the invention ultimately uses

$${ϕ}_{{C}_{cur}^{c}} and {τ}_{{C}_{cur}^{c}}$$

to resolve ambiguous cell classification labels, potentially making other adjustments to

$${Λ}_{{C}_{cur}^{c}} ,$$

as described in Section 3.5. In some embodiments of the invention, if

$${ϕ}_{{C}_{cur}^{c}} = 1 ,$$

an elevated threshold T is used in (4) to identify cell pair inconsistency for photographic video content; this adds hysteresis to the cell labelling process, so that the assignment

$${Λ}_{{C}_{cur}^{c}} = - 1$$

becomes increasingly likely after temporal inconsistency has been detected in an earlier frame.
1.3 3^{rd}: Aspect: Combining Information from Co-Located Cells

In many embodiments of the invention, the compressed frame data consists of multiple sub-bands that can be partitioned into cells of the same size, such that a cell in one sub-band is associated with essentially the same image region as corresponding cells in other sub-bands. In the case of JPEG 2000 and other wavelet based encoding techniques, each resolution level of one component usually consists of three sub-bands, known as the HL, LH and HH sub-bands, which have this property, so that cells naturally come in triplets consisting of one HL cell, one LH cell and one HH cell, as illustrated in FIG. 1 and FIG. 2. Colour imagery also consists of multiple colour components (or colour planes), each of which have their own sub-bands such that a cell in a sub-band of one colour component can be associated with the same image region as corresponding cells within corresponding sub-bands of each of the other colour components.

Thus, in many applications 9 sub-bands can be grouped together, consisting of the HL, LH and HH sub-bands at a given resolution, from each of 3 colour components, such that each cell in one sub-band is naturally associated with a corresponding cell in each of the other 8 sub-bands in the group. If some components are sub-sampled, such associations may require the use of different cell sizes in corresponding sub-bands of the different colour components, or the sets of grouped sub-bands may be smaller. In general, though, cell groups

$${G}_{cur}^{g}$$

can be identified, such that all cell

$${C}_{cur}^{c}$$

with c

$$c ∈ {𝒢}_{cur}^{g}$$

are spatially co-located within different sub-bands.

Since all cells in a group describe the same image region, they can be used to provide additional evidence of both temporal inconsistency and temporal consistency. This is done using two steps, known as “co-inconsistency induction” and “co-consistency induction,” which are applied in that order.

The “co-inconsistency induction” step is performed first. This step produces a second inconsistency trigger signal for each cell

$${C}_{cur}^{c}$$

in group

$${𝒢}_{cur}^{g} ,$$

according to

$${τ}_{{C}_{c u r}^{c}}^{( 2 )} = \{ \begin{matrix}1 & if {ϕ}_{{C}_{cur}^{c}} = 0 and {τ}_{{C}_{cur}^{j}}^{( 1 )} = 1 for any j ∈ {𝒢}_{cur}^{g} \\ 0 & otherwise\end{matrix}$$

Following the methods of Section 3.2, this second inconsistency trigger signal augments the number of conditions under which the temporal inconsistency variables

$${ϕ}_{{C}_{cur}^{c}} and {τ}_{{C}_{c u r}^{c}}$$

can become non-zero. Similar to

$${τ}_{{C}_{c u r}^{c}}^{( 1 )} = 1 ,$$

the event

$${τ}_{{C}_{c u r}^{c}}^{( 2 )} = 1$$

represents the observation of novel temporal inconsistency in the current frame. FIG. 2 shows two examples of “co-inconsistency induction.” The grouping of cells actually presents an opportunity to reduce the amount of persistent memory required to determine these temporal inconsistency variables. Rather than assigning one persistent binary state variable to each cell, for large groups it is preferable to assign a single κ-bit state variable

$${K}_{{G}_{c u r}^{g}}$$

to each group gr, where

$${𝒢}_{cur}^{g} ,$$

where

$${k}_{cur} - {K}_{{𝒢}_{c u r}^{g}}$$

can be interpreted as the index k of the last frame for which

$${τ}_{{C}_{c u r}^{j}} = 1$$

for any j

$$∈ {𝒢}_{cur}^{g} .$$

In this approach,

$${K}_{{𝒢}_{c u r}^{g}}$$

is initialized to the maximum possible value, 2^{κ}−1, which is interpreted as meaning that no cell in group

$${𝒢}_{cur}^{g}$$

has observed temporal inconsistency since its reference was last updated. For each cell

$${C}_{cur}^{c}$$

belonging to group

$${𝒢}_{cur}^{g} , {ϕ}_{{C}_{c u r}^{c}}$$

is derived from

$${K}_{{𝒢}_{c u r}^{g}}$$

according to:

$${ϕ}_{{C}_{cur}^{c}} = \{ \begin{matrix}1 & if {K}_{{𝒢}_{cur}^{g}} < {2}^{K} - 1 and {k}_{cur} - {K}_{{𝒢}_{cur}^{g}} > {k}_{{C}_{cur}^{c}}^{ref} \\ 0 & otherwise\end{matrix} ,$$

Finally, after all cells in group

$${𝒢}_{c u τ}^{g}$$

have been processed,

$${K}_{{𝒢}_{cur}^{g}}$$

is updated according to:

$${K}_{{𝒢}_{cur}^{g}} ← \{ \begin{matrix}1 & if {τ}_{{c}_{cur}^{j}} = 1 for any j ∈ {𝒢}_{cur}^{g} \\ min \{ {2}^{κ} - 1 , {K}_{{𝒢}_{cur}^{g}} + 1 \} & otherwise\end{matrix} .$$

This alternative method for tracking temporal inconsistency, produces the same values for

$${ϕ}_{{C}_{c u r}^{c}} and {δ}_{{C}_{c u r}^{c}}$$

as the simple method described in Section 3.2, so long as the reference frame gap

$${k}_{cur} - {k}_{{C}_{c u r}^{c}}^{ref} .$$

for every cell in the frame is strictly less than 2^{κ}. If some cells have a larger reference frame gap, then tie method can lose track of temporal inconsistency that has not been observed for many frames, but this is not inherently damaging to the performance of the resilient decoder, so long as κ is not too small. Preferred embodiments of the invention use κ=4 or κ=3, which significantly reduces the amount of persistent state memory required for temporal inconsistency tracking when the number of cells in a group is 9.

The “co-consistency induction” step is performed a “co-inconsistency induction.” In this step, if a cell

$${C}_{cur}^{c} ,$$

belonging to group

$${𝒢}_{cur}^{g} ,$$

has been assigned an ambiguous classification label

$${Λ}_{{C}_{c u r}^{c}} = 0 , and {ϕ}_{{C}_{c u r}^{c}} , {τ}_{{C}_{c u r}^{c}}^{( 1 )} and {τ}_{{C}_{c u r}^{c}}^{( 2 )}$$

are all 0, and if any other cell

$${C}_{cur}^{j}$$

belonging to the same group

$${𝒢}_{cur}^{g}$$

is classified as consistent

$${Λ}_{{C}_{c u r}^{j}} > 0 , with {k}_{{C}_{c u r}^{j}}^{ref} \leq {k}_{{C}_{c u r}^{c}}^{ref} ,$$

then cell

$${C}_{cur}^{c} ’ s$$

classification label is changed to

$${Λ}_{{C}_{c u r}^{c}} = 1 + {F}_{{C}_{cur}^{c}} ,$$

which is 1 (consistent with a preference for

$${C}_{ref}^{c} ) ,$$

if

$${\prod }_{{C}_{cur}^{c}} > {\prod }_{{C}_{ref}^{c}} ,$$

or 2 (consistent with a preference for preference for

$${C}_{cur}^{c} ) ,$$

if

$${\prod }_{{C}_{cur}^{c}} \leq {\prod }_{{C}_{ref}^{c}} ,$$

as given by (1). This step recognizes the fact that observations of temporal consistency between another cell in the group and its own reference provide some assurance of temporal consistency for all cells in the group, whose reference is as recent or more recent.

In some embodiments of this invention, induction is performed with a classification label

$${Λ}_{{C}_{cur}^{c}}$$

that has 3 states, given by {−1,0,1}, instead of the normal 4 states, which are {−1,0,1,2}; that is, state values of 1 and 2 are collapsed into one state value of 1 before induction. In this case, some or all induction operations, as explained in this aspect and in aspects 4 and 5 of this invention, can be performed using three-state classification labels. Once the classification label

$${Λ}_{{C}_{cur}^{c}}$$

is adjusted as explained in the 5th aspect of this invention, it is possible to convert the classification label value of 1 back to its original un-collapsed values of 1 and 2.
1.4 4^{th} Aspect: Inferring Cell Consistency from Lower Resolution Levels

This 4^{th} aspect of the invention is applicable to the case in which the encoding of each video frame was based on a multi-resolution transform structure, so that each sub-band has an associated resolution level r, where r=0 is the lowest resolution, typically consisting of a single base sub-band (or LL band) and the sub-bands associated with each higher resolution r can be understood as detail bands. In the common case of the DWT, with a classic Mallat structure, each resolution level r>0 has three detail sub-bands HLᵣ, LHᵣ and HHᵣ, whose dimensions are at least approximately proportional to 2^{r}. As a result, assuming that the cell dimensions are the same in all sub-bands, most if not all, cells from an HLᵣ sub-band have a region of influence within the reconstructed image which spans that of four cells from the HLᵣ₊₁ sub-band, if it exists, with similar statements applying to the LHᵣ and HHᵣ sub-bands. This is illustrated for two resolution levels in FIG. 2.

Reversing this relationship, for each resolution level r>1, we can say that each cell

$${C}_{cur}^{c}$$

from the HLᵣ sub-band has an “ancestor”

$${C}_{cur}^{{a}_{c}}$$

the HL₁ sub-band, whose region of influence covers that of

$${C}_{cur}^{c} .$$

Similarly each cell

$${C}_{cur}^{c}$$

from the LHᵣ sub-band has an ancestor

$${C}_{cur}^{{a}_{c}}$$

in the LHᵣ₋₁ sub-band; and each cell

$${C}_{cur}^{c}$$

from the HHᵣ sub-band has an ancetor

$${C}_{cur}^{{a}_{c}}$$

in the HHᵣ₋₁ sub-band. Not only this, but each group of cells

$${𝒢}_{cur}^{g}$$

from resolution level r>1 has an ancestor group

$${𝒢}_{cur}^{{a}_{g}}$$

from resolution level r−1, consisting of all the ancestors of the cells in group

$${𝒢}_{cur}^{g} .$$

In general, ancestor relationships such as these can be found within any multi-resolution compressed representation, regardless of whether a Mallat-structured DWT is employed by the frame encoding technology, or some other multi-scale transform.

Since the region of influence of a cell is covered by that of its ancestor, an ancestor can be used to provide additional evidence of both temporal inconsistency and temporal consistency. This is done using two steps, known as “inter-consistency induction” and “inter-inconsistency induction,” which are applied in that order.

For cells

$${C}_{cur}^{c}$$

that belong to a group

$${𝒢}_{cur}^{g}$$

of multiple co-located cells at the same resolution, these steps are applied to the group as a whole, using all cells from

$${𝒢}_{cur}^{{a}_{g}}$$

to induce consistency and then inconsistency for the cells of group

$${𝒢}_{cur}^{g} .$$

The methods of this aspect of the invention are described from this cell-group perspective, but apply equally to the case in which cells are not grouped, in which case

$${𝒢}_{cur}^{g} and {𝒢}_{cur}^{{a}_{g}}$$

each consist of one cell only, corresponding to

$${C}_{cur}^{c}$$

and its ancestor

$${C}_{c u r}^{{a}_{c}} .$$

In multi-resolution embodiments of the invention, the methods of this aspect and all preceding aspects of the invention are not applied to a group

$${𝒢}_{cur}^{g}$$

resolution level r until they have been applied to the corresponding ancestor group

$${𝒢}_{cur}^{{a}_{g}}$$

at resolution level r−1.

In embodiments of the invention, the “inter-consistency induction” step is performed immediately after any “co-consistency” step described in Section 3.3. In this step, if a cell

$${C}_{cur}^{c} ,$$

belonging to group

$${𝒢}_{cur}^{g} ,$$

has been assigned an ambiguous classification label

$${Λ}_{{C}_{c u r}^{c}} = 0 , and {ϕ}_{{C}_{c u r}^{c}} , {τ}_{{C}_{c u r}^{c}}^{( 1 )} and {τ}_{{C}_{c u r}^{c}}^{( 2 )}$$

are all 0, and if any ancestor cell

$${C}_{cur}^{{a}_{j}}$$

belonging to a

$${𝒢}_{cur}^{{a}_{ℊ}}$$

is classified as consistent

$${Λ}_{{C}_{cur}^{{a}_{j}}} > 0 ,$$

with

$${k}_{{C}_{cur}^{{a}_{j}}}^{ref} \leq {k}_{{C}_{cur}^{c}}^{ref} ,$$

then cell

$${C}_{cur}^{c} {}^{'} s$$

classification label is changed to

$${Λ}_{{C}_{c u r}^{c}} = 1 + {F}_{{C}_{c u r}^{c}} ,$$

which is 1 (consistent with a preference for

$${C}_{ref}^{c} ) ,$$

if

$${Π}_{{C}_{c u r}^{c}} > {Π}_{{C}_{ref}^{c}} ,$$

or 2 (consistent with a preference for preference for

$${C}_{c u r}^{c} ) , if {Π}_{{C}_{c u r}^{c}} \leq {Π}_{{C}_{ref}^{c}} ,$$

as given by (1).

Note that the “inter-consistency induction” step and the “co-consistency induction” step described in Section 3.3 can actually be performed together, since they both affect cells for which

$${Λ}_{{C}_{c u r}^{c}} = 0 , and {ϕ}_{{C}_{c u r}^{c}} , {τ}_{{C}_{c u r}^{c}}^{( 1 )} and {τ}_{{C}_{c u r}^{c}}^{( 2 )}$$

are all 0, providing complementary conditions under which the cell's label is changed to

$${Λ}_{{C}_{c u r}^{c}} = 1 + {F}_{{C}_{c u r}^{c}} .$$

After applying all relevant “co-inconsistency induction”, “co-consistency induction” and “inter-consistency induction” steps to group

$${𝒢}_{cur}^{ℊ} ,$$

as described above, the “inter-inconsistency induction” step is performed last. This step forms a third inconsistency trigger signal

$${τ}_{{C}_{c u r}^{c}}^{( 3 )}$$

for each cell

$${C}_{c u r}^{c}$$

in group

$${𝒢}_{cur}^{ℊ} .$$

In some embodiments of the invention, this third form of novel temporal inconsistency is observed if all cells

$${C}_{cur}^{c}$$

in group

$${𝒢}_{cur}^{g} have {Λ}_{{C}_{cur}^{c}} \leq 0$$

and any ancestor cell

$${C}_{cur}^{{a}_{j}}$$

in group

$${𝒢}_{cur}^{{a}_{g}}$$

has

$${τ}_{{C}_{cur}^{{a}_{j}}} = 1 ,$$

noting that

$${τ}_{{C}_{cur}^{{a}_{j}}}$$

is the logical OR of all of

$${τ}_{{C}_{cur}^{{a}_{j}}}^{( 1 )} , {τ}_{{C}_{cur}^{{a}_{j}}}^{( 2 )} and {τ}_{{C}_{cur}^{{a}_{j}}}^{( 3 )} .$$

### That is,

$${τ}_{{C}_{cur}^{c}}^{( 3 )} = \{ \begin{matrix}1 & if ( {Λ}_{{C}_{cur}^{i}} \leq 0 , ∀ i ∈ {𝒢}_{cur}^{g} and ∃ j ∈ {𝒢}_{cur}^{g} such that {τ}_{{C}_{cur}^{{a}_{j}}} = 1 ) . \\ 0 & otherwise\end{matrix}$$

In these embodiments, the

$${τ}_{{C}_{cur}^{c}}^{( 3 )}$$

temporal inconsistency trigger signal can propagate from low resolution to higher resolutions recursively, being blocked only by the presence of temporally consistent cells (i.e., Λ>0). Note, however, that the “co-consistency induction” and “inter-consistency induction” steps that are performed first, convert either all or none of the ambiguous cells in group

$${𝒢}_{cur}^{g}$$

to consistent cells; any such conversion both results in the recursive propagation of temporal consistency to higher resolution levels and blocks the recursive propagation of temporal inconsistency from lower to higher resolutions. Note also that

$${τ}_{{C}_{cur}^{c}}^{( 3 )}$$

can be 1, even if

$${ϕ}_{{C}_{cur}^{c}} = 1 ,$$

meaning that temporal inconsistency has been detected in preceding frames for cell

$${C}_{cur}^{c} .$$

This is not a violation of the novelty principle, since the event

$${τ}_{{C}_{cur}^{c}}^{( 3 )} = 1$$

can only arise from the novel detection of temporal inconsistency at a lower resolution level. FIG. 2 shows an example of such “inter-inconsistency induction.”

In other embodiments of the invention, the

$${τ}_{{C}_{cur}^{c}}^{( 3 )}$$

temporal inconsistency trigger signal is determined according to:

$${τ}_{{C}_{cur}^{c}}^{( 3 )} = \{ \begin{matrix}1 & if ( \begin{matrix}{Λ}_{{C}_{cur}^{i}} \leq 0 , ∀ i ∈ {𝒢}_{cur}^{g} and ∃ j ∈ {𝒢}_{cur}^{g} such that \\ {τ}_{{C}_{cur}^{{a}_{j}}}^{( 1 )} = 1 or ( {τ}_{{C}_{cur}^{{a}_{j}}}^{( 3 )} = 1 and ( \begin{matrix}( ∃ m ∈ {𝒢}_{cur}^{g} such that {Λ}_{{C}_{cur}^{{a}_{m}}} < 0 ) or \\ {Λ}_{{C}_{cur}^{{a}_{m}}} = 0 , ∀ m ∈ {𝒢}_{cur}^{g} and {Θ}_{{𝒢}_{cur}^{g}} = 0\end{matrix} ) )\end{matrix} ) \\ 0 & otherwise\end{matrix}$$

Here,

$${Θ}_{{𝒢}_{cur}^{g}} ∈ \{ 0 , 1 \}$$

is used to identify a “power inversion” property, which is calculated from all cells within

$${𝒢}_{cur}^{g}$$

and their ancestors within

$${𝒢}_{cur}^{{a}_{g}} ,$$

based on averages of their squared reference sample values. Specifically, let

$${Ω}_{{C}_{cur}^{c}}^{𝒜} ⊆ {Ω}_{{C}_{cur}^{{a}_{c}}}$$

denote a collection of sample locations within the support of ancestor cell

$${C}_{cur}^{{a}_{c}}$$

that most closely reflects the region of support of the higher resolution cell

$${C}_{cur}^{c} ,$$

noting that in typical multi-scale representations the lower resolution sub-bands are sub-sampled by a factor of 2 in each direction relative to the next higher resolution sub-bands, so that the number of samples

$$‖ {Ω}_{{C}_{cur}^{c}}^{𝒜} ‖ in {Ω}_{{C}_{cur}^{c}}^{𝒜}$$

is only one quarter the number of samples

$$‖ {Ω}_{{C}_{cur}^{c}} ‖$$

that are in

$${Ω}_{{C}_{cur}^{c}} .$$

Then write

$${H}_{{𝒢}_{cur}^{g}} = {\sum }_{c ∈ {𝒢}_{cur}^{g}} {\sum }_{n ∈ {Ω}_{{C}_{cur}^{c}}} {( {y}_{{C}_{ref}^{c}} [ n ] )}^{2} ,$$

$${N}_{{𝒢}_{cur}^{g}} = {\sum }_{c ∈ {𝒢}_{cur}^{g}} ‖ {Ω}_{{C}_{cur}^{c}} ‖ ,$$

$${H}_{{𝒢}_{cur}^{g}}^{𝒜} = {\sum }_{c ∈ {𝒢}_{cur}^{g}} {\sum }_{n ∈ {Ω}_{{C}_{cur}^{c}}^{𝒜}} {( {y}_{{C}_{ref}^{{a}_{c}}} [ n ] )}^{2} and$$

$${N}_{{𝒢}_{cur}^{g}}^{𝒜} = {\sum }_{c ∈ {𝒢}_{cur}^{g}} ‖ {Ω}_{{C}_{cur}^{c}}^{𝒜} ‖ ,$$

so that

$${H}_{{𝒢}_{cur}^{g}} / {N}_{{𝒢}_{cur}^{g}} and {H}_{{𝒢}_{cur}^{g}}^{𝒜} / {N}_{{𝒢}_{cur}^{g}}^{𝒜}$$

represent the reference sample powers within

$${𝒢}_{cur}^{g} and {𝒢}_{cur}^{{a}_{g}} ,$$

respectively, limited to just those parts of the ancestor cells whose region of influence in the image is most similar to the corresponding cells in

$${𝒢}_{cur}^{g} .$$

### Then

$${Θ}_{{𝒢}_{cur}^{g}} = \{ \begin{matrix}1 & if \frac{{H}_{{𝒢}_{cur}^{g}}}{{N}_{{𝒢}_{cur}^{g}}} > α \cdot \frac{{H}_{{𝒢}_{cur}^{g}}^{𝒜}}{{N}_{{𝒢}_{cur}^{g}}^{𝒜}} \\ 0 & otherwise\end{matrix}$$

where α is a power-inversion threshold that is selected so that

$${Θ}_{{𝒢}_{cur}^{g}} = 1$$

corresponds to the relatively unusual condition in which the higher resolution samples have more power than their lower resolution counterparts. In these embodiments of the invention the quantities

$${H}_{{𝒢}_{cur}^{g}} and {H}_{{𝒢}_{cur}^{g}}^{𝒜}$$

can all be computed concurrently with the cell powers

$${P}_{{C}_{cur}^{c}}$$

defined in (3), without substantial implementation overhead.

To understand the use of power inversion in the derivation of

$${τ}_{{C}_{cur}^{c}}^{( 3 )}$$

above, we note firstly that power inversion is not usually stable under temporal change; even pure translation shifts can reverse power inversion, due to a lack of shift invariance resulting from the substantial spectral overlap between low- and high-pass sub-band filters in the transform. That is, even if a higher resolution cell exhibits higher power than a lower resolution ancestor at one point in time, we do not expect this to remain true if the frame data is undergoing significant geometric change. So, if temporal change exists in the higher resolution, one might reasonably expect to observe the temporal change at some point within the lower resolution also, especially because lower resolution sub-bands tend to be much more finely quantized. The above equation for

$${τ}_{{C}_{cur}^{c}}^{( 3 )}$$

makes use of the power inversion attribute

$${Θ}_{{𝒢}_{cur}^{ℊ}}$$

only when

$${τ}_{{C}_{cur}^{{a}_{j}}}^{( 3 )} = 1$$

and all cells in

$${𝒢}_{cur}^{{a}_{ℊ}}$$

are ambiguous. If this happens then the temporal inconsistency we would expect to see at the lower resolution, in the event of geometric change, is not being observed, and so in the event of power inversion, it is reasonable to consider that the higher power cells of

$${𝒢}_{cur}^{ℊ}$$

are likely to belong to a static texture. As a result, it is reasonable to block the propagation of temporal inconsistency from much lower resolutions, via

$${τ}_{{C}_{cur}^{c}}^{( 3 )}$$

when

$${Θ}_{{𝒢}_{cur}^{ℊ}} = 1$$

and none of the cells in

$${𝒢}_{cur}^{{a}_{ℊ}} has Λ < 0 ,$$

which would explicitly suggest temporal
inconsistency.

It should be apparent to a reader skilled in the art, that there are many variations of the method described here for assessing “power inversion,” that could be expected to have similar properties. For example, the squaring operations involved in the calculation of a

$$\begin{matrix}{H}_{{𝒢}_{cur}^{ℊ}} \\ and {H}_{{𝒢}_{cur}^{ℊ}}^{𝒜} ,\end{matrix}$$

could potentially be replaced by absolute values in order to reduce numerical complexity.

Note that in all embodiments of the invention discussed here, all cells

$${C}_{cur}^{c}$$

in a group

$${𝒢}_{cur}^{ℊ}$$

for which

$${ϕ}_{{C}_{cur}^{c}} = 0 ,$$

receive the same values fo

$${τ}_{{C}_{cur}^{c}}^{( 3 )} and {τ}_{{C}_{cur}^{c}}^{( 2 )}$$

and hence ultimately the same value for

$${τ}_{{C}_{cur}^{c}} ,$$

so the memory efficient alternative method for keeping track of temporal inconsistency state iin nation, as discussed in Section 3.3, is appropriate also to be used in conjunction with the methods of this 4^{th} aspect of the invention.

### 1.5 5^{th} Aspect: Adjustment of Cell Classification Labels

After applying the methods associated with the first four aspects of the invention, there are often some cells which have the ambiguous classification label

$${Λ}_{{C}_{cur}^{c}} = 0.$$

To address this ambiguous cells have their labels converted to

$${Λ}_{{C}_{cur}^{c}} = - 1$$

(inconsistent) whenever either of the temporal inconsistency of tracking variables

$${ϕ}_{{C}_{cur}^{c}} or {τ}_{{C}_{cur}^{c}}$$

is 1. In cases where

$$\begin{matrix}{ϕ}_{{C}_{cur}^{c}} and \\ {τ}_{{C}_{cur}^{c}}\end{matrix}$$

are both 0, and

$${\prod }_{{C}_{cur}^{c}} \leq {\prod }_{{C}_{ref}^{c}} ,$$

ambiguous cells may be resolved either to

$${Λ}_{{C}_{cur}^{c}} = - 1$$

or

$${Λ}_{{C}_{cur}^{c}} = 2 ,$$

both of which mean that the referred way to reconstruct the frame is to use the samples of

$${C}_{cur}^{c}$$

rather than

$${C}_{ref}^{c} .$$

### Otherwise,

$${ϕ}_{{C}_{cur}^{c}} and {τ}_{{C}_{cur}^{c}}$$

are both 0 and

$$\begin{matrix}{\prod }_{{C}_{cur}^{c}} > \\ {\prod }_{{C}_{ref}^{c}} ,\end{matrix}$$

so ambiguous cells should be resolved either to

$${Λ}_{{C}_{cur}^{c}} = - 1 or {Λ}_{{C}_{cur}^{c}} = 1.$$

In this last case, the distinction between these two possible ways to resolve ambiguity is important, since it affects the way in which the current video frame will be reconstructed, as discussed in Section 3.6. The remainder of this section is concerned with this case.

When

$${Λ}_{{C}_{cur}^{c}} = 0 and {ϕ}_{{C}_{cur}^{c}} and {τ}_{{C}_{cur}^{c}}$$

are both 0 and

$${\prod }_{{C}_{cur}^{c}} > {\prod }_{{C}_{ref}^{c}} ,$$

some embodiments of the invention take the conservative position that

$${C}_{cur}^{c}$$

may be temporally inconsistent, converting the ambiguous label to

$${Λ}_{{C}_{c u r}^{c}} = - 1 .$$

In preferred embodiments of the invention, however, the ambiguous label is converted instead to

$${Λ}_{{C}_{c u r}^{c}} = 1$$

(consistent) if the “power inversion” property holds, as described in 3.4, meaning that

$${C}_{cur}^{c}$$

belong to a group

$${𝒢}_{cur}^{g}$$

for which

$${Θ}_{{𝒢}_{c u r}^{g}} = 1 .$$

In applications where the resilient decoder has reason to believe that the encoded video content comes from a JSIV-like encoder or distribution server, which has intentionally assigned higher quality to code-blocks where significant temporal change was observed, preferred embodiments should convert all ambiguous labels for which

$${ϕ}_{{C}_{c u r}^{c}} and {τ}_{{C}_{c u r}^{c}}$$

are both 0 and

$${\prod }_{{C}_{cur}^{c}} > {\prod }_{{C}_{ref}^{c}} to {Λ}_{{C}_{cur}^{c}} = 1$$

(consistent).

In further embodiments of the invention, prior evidence of temporal inconsistency may be used to assist in resolving ambiguous cells for which

$${ϕ}_{{C}_{c u r}^{c}} and {τ}_{{C}_{c u r}^{c}}$$

are both 0 and

$${\prod }_{{C}_{c u r}^{c}} > {\prod }_{{C}_{ref}^{c}} .$$

In particular, when the memory efficient inconsistency tracking mechanism described in Section 3.3 is employed, such that each cell group

$${𝒢}_{cur}^{g}$$

is assigned a persistent K-bit state-variable

$${K}_{{𝒢}_{c u r}^{g}}$$

from which

$${ϕ}_{{C}_{c u r}^{c}}$$

is derived, the special case

$${K}_{{𝒢}_{c u r}^{g}} = {2}^{κ} - 1$$

means that no recent temporal inconstancy has been observed within any cell of the group. If this is true, these embodiments of the invention convert ambiguous cells within the group to

$${Λ}_{{C}_{c u r}^{c}} = 1$$

(consistent), as opposed to

$${Λ}_{{C}_{cur}^{c}} = - 1.$$

Still further embodiments of the invention may use spatially neighbouring cells, whose classification labels have already been finalised, in the resolution of ambiguous cells for which

$${ϕ}_{{C}_{cur}^{c}} and {τ}_{{C}_{cur}^{c}}$$

are both 0 and

$${\prod }_{{C}_{cur}^{c}} > {\prod }_{{C}_{ref}^{c}} .$$

In particular, if any neighbour

$${C}_{{C}_{cur}^{c}}^{nbr}$$

of cell

$${C}_{cur}^{c}$$

has already been assigned a label indicating temporal consistency

$${Λ}_{{C}_{{C}_{cur}^{c}}^{nbr}} > 0 ,$$

with

$$\begin{matrix}{k}_{{C}_{{C}_{cur}^{c}}^{nbr}}^{ref} \leq \\ {k}_{{C}_{cur}^{c}}^{ref} ,\end{matrix}$$

then the ambiguous label for

$${C}_{cur}^{c}$$

may be converted to

$${Λ}_{{C}_{cur}^{c}} = 1$$

(consistent), as opposed to

$${Λ}_{{C}_{cur}^{c}} = - 1.$$

In particularly conservative embodiments of the invention, when

$${ϕ}_{{C}_{cur}^{c}} = 1 or {τ}_{{C}_{cur}^{c}} = 1 ,$$

the cell classification label produced by earlier aspects of the invention is always converted to

$${Λ}_{{C}_{cur}^{c}} = - 1 ,$$

regardless of the initial label assigned. In these embodiments, once temporal inconsistency has been observed in one frame, the cell will continue to be treated as inconsistent from its reference in all future frames, until the reference code-block for the cell is updated so that

$${ϕ}_{{C}_{cur}^{c}}$$

returns to 0. In preferred embodiments, however, non-ambiguous classification labels are not modified by

$${ϕ}_{{C}_{cur}^{c}} or {τ}_{{C}_{cur}^{c}} ,$$

but the thereshold T used in (4) to identify temporal consistency for photographic video content may be adjusted by

$${ϕ}_{{C}_{cur}^{c}} ,$$

as described in Section 3.2.

### 1.6 6^{th} Aspect: Determination and Management of Reference Code-Blocks

As explained previously, this invention relies upon a reference buffer to store code-blocks received from previous frames. While it is possible to store the decoded sample values for those code-blocks, preferred embodiments of the invention store only the reference code-block bit-streams received by the decoder, so as to minimize the memory size and memory bandwidth associated with reference buffer transactions.

In the event that the reference buffer does store decoded sample values and these sample values are able to be updated on a cell-by-cell basis, it is sufficient simply to update the reference samples for cell

$${C}_{cur}^{c}$$

with the values

$${q}_{{C}_{cur}^{c}} [ n ]$$

whenever the final classification outcome

$${Λ}_{{C}_{cur}^{c}} \neq 1 ,$$

since

$${Λ}_{{C}_{cur}^{c}} = 1$$

is the only classification outcome for which the existing reference samples

$${q}_{{C}_{ref}^{c}} [ n ]$$

can be considered superior to

$${q}_{{C}_{cur}^{c}} [ n ] .$$

In most embodiments of the invention, however, such cell-by-cell updates are not possible, since they require either a high memory bandwidth interface to the reference buffer or an encoded reference buffer whose content must be directly encoded within the decoder, both of which come with high implementation cost—the only exception to this is where a code-block consists of only one cell, but that special case is covered by the methods described below.

In the reference buffer management methods described below, it is assumed that the reference buffer contains only code-block bit-streams previously received by the decoder. Moreover, in the event that code-block dimensions change from frame to frame, it is assumed that reference code-blocks with incompatible dimensions are ignored or discarded. As a result, whenever a reference code-block exists, not only does Bret have the same region of support as B_{cur}, but all frames k in the range

$${k}_{{B}_{cur}}^{ref} \leq k \leq {k}_{cur}$$

necessarily contain code-blocks with the same region of support as B_{cur}. As a result, there is a well-defined sequence of average log-quantization interval length values

$${\prod }_{{B}_{cur}}^{k} ,$$

corresponding to the Π_{B}_{_{cur}} values that were evaluated when k was the current frame index, such that

$$\begin{matrix}{\prod }_{{B}_{cur}}^{{k}_{{B}_{cur}}^{ref}} = {\prod }_{{B}_{ref}} and \\ {\prod }_{{B}_{cur}}^{{k}_{{B}_{cur}}^{ref}} = {\prod }_{{B}_{cur}} .\end{matrix}$$

Some embodiments of the invention use these

$${\prod }_{{B}_{cur}}^{k}$$

values to help determine the point at which a reference code-block should be replaced within the reference buffer.

In some embodiments of the invention, the reference buffer stores only one reference code-block B_{ref} for each code-block B_{cur} that may appear within a current video frame. In other embodiments of the invention, a rotating buffer may be employed to store all received code-blocks from the past K frames, where K is large enough to cover all reference-to-current frame separations

$${k}_{cur} - {k}_{{B}_{cur}}^{ref}$$

that are likely to be of interest. While such embodiments require more memory, they have essentially the same memory bandwidth requirement, since for each code-block B_{cur} in the current frame, there is still only one designated reference frame

$${k}_{{B}_{cur}}^{ref}$$

from which a reference code-block B_{ref} can be accessed by the resilient decoding methods of this invention. In general, this reference frame

$${k}_{{B}_{cur}}^{ref}$$

varies from block to block.

Regardless of how the reference buffer is organized, the key consideration for this second aspect of the invention is the determination of

$${k}_{{B}_{cur}}^{ref\_nxt} ,$$

identifying the frame index of the reference code-block that will be accessed by the resilient decoding procedure when it processes code-block B_{cur} within the next frame kₙₓₜ=k_{cur}+1. That is, a resilient decoder that is processing a current frame k_{cur}, must determine the reference frame

$${k}_{{B}_{cur}}^{ref\_nxt}$$

that will be used in the next frame.

In some cases, the determination of

$${k}_{{B}_{cur}}^{ref \_ nxt}$$

is rendered trivial by the nature of the application, or equivalently the operating context of the resilient decoder. For example, if the invention is used only for error resilient decoding applications, then the natural choice is

$${k}_{{B}_{cur}}^{ref \_ nxt} = \{ \begin{matrix}{k}_{cur} & if {B}_{cur} is error free \\ {k}_{{B}_{cur}}^{ref} & if {B}_{cur} is corrupted by free\end{matrix}$$

As another example, if the invention is used for resilient decoding of content delivered by a JSIV server, which actively selects the code-blocks that will be assigned non-empty bit-streams on the basis of a temporal change detection algorithm, the natural choice is

$${k}_{{B}_{cur}}^{ref \_ nxt} = \{ \begin{matrix}{k}_{cur} & if {B}_{cur} is non - empty \\ {k}_{{B}_{cur}}^{ref} & if {B}_{cur} is empty\end{matrix}$$

In other applications, an encoder or video distribution server may deliberately reduce the quality associated with certain code-blocks to conserve communication bandwidth, while including sufficient information in the communicated data to identify (mark) those code-blocks whose quality has not been reduced. This could be done as part of a communication protocol, by inserting markers into the codestream or otherwise. If the resilient decoder is aware of the protocol or marker codes, then it can use them to update

$${k}_{{B}_{cur}}^{ref \_ nxt}$$

as follows:

$${k}_{{B}_{cur}}^{ref \_ nxt} = \{ \begin{matrix}{k}_{cur} & if {B}_{cur} is marked as a high quality code - block \\ {k}_{{B}_{cur}}^{ref} & if {B}_{cur} is not marked as a high quality code - block\end{matrix}$$

All of these are examples of contextual hints, that allow the resilient decoder to determine

$${k}_{{B}_{cur}}^{ref \_ nxt}$$

without any real decision process. The rest of this section considers the case in which there are no significant contextual hints. In the absence of contextual hints, embodiments of the invention determine

$${k}_{{B}_{cur}}^{ref \_ nxt}$$

based on the cell labels

$${Λ}_{{C}_{cur}^{c}}$$

deduced in the current frame k_{cur}, for all of the cells c∈ [symbol] B_{cur} associated with code-block B_{cur}, after taking into account any adjustments that are made by the various aspects of this invention. The information provided by the adjusted labels is supplemented by inherent measures of code-block quality such as the log-quantization interval statistics Π_{B}_{_{cur}}, Π_{B}_{_{ref}} and Π̅_{B}_{_{cur}}, as illustrated in FIG. 3.

FIG. 4 is an illustration of reference buffer management. Code-blocks 310 arriving as part of the compressed data for a frame 320 are selectively used to update the reference buffer 330, based on contextual hints that are implied by or explicitly contained within the received compressed video data, or a decision process that takes into account the adjusted cell labels and log-quantization interval statistics Π_{B}_{_{cur}}, Π_{B}_{_{ref}} and Π̅_{B}_{_{cur}}.

To understand the decision process, note that only those cells for which Λ=1 actually benefit from the currently installed reference code-block and this is likely to continue to be true in the future. Thus, if there are no such cells c∈ [symbol] _{B}_{_{cur}} for which

$${Λ}_{{C}_{cur}^{c}} = 1 ,$$

then

$${k}_{{B}_{cur}}^{ref \_ nxt}$$

should be updated to k_{cur}. Moreover, this condition is certain to occur if B_{cur} has the same or higher quality compared to B_{ref}, as identified by F_{B}_{_{cur}}−1, or equivalently, Π_{B}_{_{cur}}≤Π_{B}_{_{ref}}. To address the more general case, in which some cells c∈ [symbol] _{B}_{_{cur}} have

$${Λ}_{{C}_{cur}^{c}} = 1 ,$$

while others do not, various heuristics can be employed to determine whether

$${k}_{{B}_{cur}}^{ref \_ nxt}$$

should be updated to k_{cur} or retained as

$${k}_{{B}_{cur}}^{ref} ,$$

but preferred embodiments use the historical average log-quantization interval statistics

$${\prod }_{{B}_{cur}}^{k}$$

introduced above. In particular, write

$${\overline{\prod }}_{{B}_{cur}}^{k}$$

for a measure of the average value of

$${\prod }_{{B}_{cur}}^{k}$$

over all frames from

$${k}_{{B}_{cur}}^{ref} + 1 to k .$$

The decoder then uses

$${\overline{\prod }}_{{B}_{cur}}^{{k}_{cur}} , {\prod }_{{B}_{cur}} and {\prod }_{{B}_{ref}} ,$$

together with the fraction Γ_{B}_{_{cur}} of cells in code-block B_{cur} for which Λ=1, to determine whether or not the reference frame should be updated. Specifically,

$${k}_{{B}_{cur}}^{ref \_ nxt} = \{ \begin{matrix}{k}_{cur} & if {Γ}_{{B}_{cur}} \cdot {4}^{{\prod }_{{B}_{ref}}} + ( 1 - {Γ}_{{B}_{cur}} ) \cdot {4}^{{\overline{{\prod }^{}}}_{{B}_{cur}}^{{k}_{cur}}} \geq {4}^{{\prod }_{{B}_{cur}}} \\ {k}_{{B}_{cur}}^{ref} & otherwise\end{matrix} ,$$

$$where$$

$${Γ}_{{B}_{cur}} = {\sum }_{c ∈ {𝒫}_{{B}_{cur}}} \{ \begin{matrix}\frac{1}{‖ {𝒫}_{{B}_{cur}} ‖} & if {Λ}_{{C}_{cur}^{c}} = 1 \\ 0 & otherwise\end{matrix}$$

and ∥ [symbol] _{B}_{_{cur}}∥ is the number of cells in the partition of B_{cur}.

In the special case where

$${k}_{{B}_{cur}}^{ref} = {k}_{cur} - 1 ,$$

meaning that the reference block has only just been updated in the previous frame,

$${\overline{\prod }}_{{B}_{cur}}^{{k}_{cur}}$$

is identical to Π_{B}_{_{cur}} and so the reference selection

$${k}_{{B}_{cur}}^{ref \_ nxt} = \{ \begin{matrix}{k}_{cur} & if {Γ}_{{B}_{cur}} \cdot {4}^{{\prod }_{{B}_{ref}}} \geq {Γ}_{{B}_{cur}} {{4}^{{\prod }_{{B}_{cur}}}}^{} \\ {k}_{{B}_{cur}}^{ref} & otherwise\end{matrix} = \{ \begin{matrix}{k}_{cur} & if {\prod }_{{B}_{ref}} \geq {\prod }_{{B}_{cur}} or {Γ}_{{B}_{cur}} = 0 \\ {k}_{{B}_{cur}}^{ref} & otherwise\end{matrix}$$

In fact, whenever Π_{B}_{_{cur}}≤Π_{B}_{_{ref}} no cell in the block can have Λ−1, so that Γ_{B}_{_{cur}} is certainly 0 and the reference block is necessarily updated

$$- {k}_{{B}_{cur}}^{ref \_ nxt} = {k}_{cur} .$$

This condition also arises when there is no reference code-block, since then Π_{B}_{_{ref}} is taken to be unbounded (or ∞).

On the contrary, if

$${\prod }_{{B}_{cur}} > {\prod }_{{B}_{ref}} and {k}_{{B}_{cur}}^{ref} < {k}_{cur} - 1 then {\overline{\prod }}_{{B}_{cur}}^{{k}_{cur}}$$

is necessarily larger than Π_{B}_{_{ref}}, since the fact that the reference block was not updated at any of the frame indices

$$k > {k}_{{B}_{cur}}^{ref}$$

means that

$${\prod }_{{B}_{cur}}^{k}$$

must have been larger than

$${\prod }_{{B}_{ref}}^{k}$$

for each k contributing to the average in

$${\overline{\prod }}_{{B}_{cur}}^{{k}_{cur}} .$$

It follows that the reference block can only be updated if

$${\prod }_{{B}_{cur}} > {\overline{\prod }}_{{B}_{cur}}^{{k}_{cur}} ,$$

meaning that the current instance of the code-block has higher quality than the average experienced since the reference block was last updated. Moreover, the increase in quality needs to be sufficient to justify an update, considering the extent to which the reference block's cells are still being beneficially used by the resilient decoding procedure.

In some embodiments of the invention, the average

$${\overline{\prod }}_{{B}_{cur}}^{{k}_{cur}}$$

is computed by maintaining an accumulator

$${\prod }_{{B}_{c u r}}^{a c c}$$

for each code-block B_{cur}, which is updated according to

$${\prod }_{{B}_{c u r}}^{a c c} ← {\prod }_{{B}_{c u r}}^{acc} + {\prod }_{{B}_{c u r}}$$

during the processing of a current frame k_{cur}, after which

$${\overline{\prod }}_{{B}_{cur}}^{{k}_{c u r}}$$

is found from

$${\prod }_{{B}_{c u r}}^{a c c} / ( {k}_{cur} - {k}_{{B}_{cur}}^{ref} ) .$$

If the decision is subsequently made to set

$${k}_{{B}_{cur}}^{ref \_ nxt} = {k}_{cur} ,$$

then the accumulator

$${\prod }_{{B}_{c u r}}^{acc}$$

is reset to 0. In other embodiments of the invention, a recursive averaging procedure may be employed, which may have slightly lower implementation complexity. In all such embodiments, however, one statistic related to

$${\overline{\prod }}_{{B}_{c u r}}^{k}$$

must be stored for each code-block in a frame.

### 1.7 7^{th} Aspect: Cell Merging and Decoded Frame Reconstruction

After generation and adjustment of cell labels according to all previous aspects of the invention, no ambiguities remain so that each cell

$${C}_{cur}^{c}$$

has one of the labels

$${Λ}_{{C}_{c u r}^{c}} = - 1$$

(inconsistent),

$${Λ}_{{C}_{c u r}^{c}} = 1$$

(consistent with a preference for

$${C}_{ref}^{c} ) or {Λ}_{{C}_{c u r}^{c}} = 2$$

(consistent, with a preference for

$${C}_{cur}^{c} ) .$$

Embodiments of this invention then reconstruct the frame using the sub-band samples

$${y}_{{c}_{ref}^{c}} [ n ] if {Λ}_{{C}_{c u r}^{c}} = 1 and {y}_{{C}_{c u r}^{c}} [ n ] if {Λ}_{{C}_{c u r}^{c}} \neq 1 ,$$

for all

$$n ∈ {Ω}_{{C}_{c u r}^{c}} .$$

The reconstruction is completed by applying any relevant inverse transformations (e.g., inverse DWT transformation, in the case of JPEG 2000) to the resulting reconstructed sub-band samples.

In embodiments that process code-blocks produced by block-based transforms, as opposed to overlapped transforms such as the DWT, it is preferable to merge the two candidates

$${y}_{{C}_{ref}^{c}} and {y}_{{C}_{c u r}^{c}}$$

for a cell's reconstructed sample values in a manner that is less likely to create artificial discontinuities at the boundaries between transform blocks. One way to do this is to use the well-known Laplacian Pyramid blending approach(for example as described in E. Adelson, C. Anderson, J. Bergen, P. Burt and J. Ogden, “Pyramid methods in image processing,” RCA Engineer, vol. 29, no. 6, pp. 33-41, 1984), but other methods will be known to those skilled in the art.

### 1.8 8^{th} Aspect: a Method to Reduce Block-Decoding Resources

The resilient decoding processes described in this invention require up to two separate code-blocks to be decoded for each actual code-block in the compressed representation of a video frame. This doubling of decoding resources is the main implementation cost of the approach, in comparison to a simple non-resilient decoder. Of course, two full code-blocks only need to be decoded if both B_{cur} and B_{ref} are non-empty, but even if one of the two is often empty, real-time hardware deployments normally need to provide sufficient resources to address the worst case.

When the sub-bands arise from a multi-resolution transform of each video frame, as described in Section 3.4, one way to greatly reduce the decoding resources required for resilient decoding is to arrange for the code-blocks from one or more of the highest resolution sub-bands to be assigned classification labels that depend only on information that can be deduced from lower resolution levels, together with code-block attributes that can be inferred without actual decoding. Specifically, each such high-resolution code-block B_{cur} is assigned exactly one cell C_{cur} such that Ω_{C}_{_{cur}}−Ω_{B}_{_{cur}}, and an initially ambiguous classification label Λ_{C}_{_{cur}}=0, together with Π_{C}_{_{cur}}=Π_{B}_{_{cur}} and Π_{C}_{_{ref}}=Π_{B}_{_{ref}} log-quantization interval properties that are deduced from the number of available coding passes in B_{cur} and its reference B_{ref}, as described in Section 3.1. The methods of Aspect 4 and Aspect 5 of the invention are then used to resolve the initially ambiguous label for each high-resolution cell into a non-ambiguous label Λ_{C}_{_{cur}} ∈{−1,1,2}, based on the more informative labels assigned to lower resolution cells, whose current and reference code-blocks are fully decoded.

In this way, A_{C}_{_{cur}} is determined without actually decoding B_{cur} or its reference B_{ref}, and since there is only one cell in each high-resolution code-block, the decoder proceeds as follows:
if A_{C}_{_{cur}}=1, only B_{ref} is decoded to produce C_{ref}, which is then used in reconstructing the video frame;
otherwise, only B_{cur} is decoded to produce C_{cur}, which is then used in reconstructing the video frame, while also being used to update the reference buffer.

It will be understood to persons skilled in the art of the invention that many modifications may be made without departing from the spirit and scope of the invention.

In the claims which follow and in the preceding description of the invention, except where the context requires otherwise due to express language or necessary implication, the word “comprise” or variations such as “comprises” or “comprising” is used in an inclusive sense, i.e. to specify the presence of the stated features but not to preclude the presence or addition of further features in various embodiments of the invention.

It is to be understood that, if any prior art publication is referred to herein, such reference does not constitute an admission that the publication forms a part of the common general knowledge in the art, in Australia or any other country.

1. A method for resilient decoding of a sequence of video frames, each having been transformed to produce a plurality of sample blocks, that have been independently encoded, the encoded sample blocks being identified herein as code-blocks, the method involving a reference buffer that is capable of selectively storing previously received code-blocks from the encoded video sequence, where a code-block within a given frame, identified here as the current code-block of the current frame, is processed using the following steps:
a) decoding the current code-block to produce a current block of sample values;
b) obtaining a corresponding reference block of decoded reference block sample values for a previous frame in the video sequence by accessing the reference buffer and performing any required decoding operations to obtain said reference block samples values;
c) partitioning each of the current and reference blocks of decoded sample values into one or more cells, each cell of the current block being in one to one correspondence with a cell of the reference block;
d) comparing corresponding cells of the current and reference block to produce an initial classification label for each cell pair, the label having at least three possible values that identify the cell as inconsistent, ambiguous or consistent; and
e) resolving cell pairs initially labelled as ambiguous to consistent or inconsistent by a label adjustment step that uses the labels assigned to other cells.

2. The method of claim 1, wherein the initial classification label for a cell pair has four possible values that identify the cell as one of: a) inconsistent; b) ambiguous; c) consistent, with a preference for using the cell of the reference block in representations of the current frame; d) and consistent, with a preference for using the cell of the current block in representations of the current frame.

3. The method of claim 1, wherein comparing corresponding cells is based on a comparison of the quantization intervals associated with each sample in the current and reference cell, such that:
a) the cell pair is labelled inconsistent if the quantization interval associated with at least one decoded sample in the current cell is inconsistent with the quantization interval associated with the corresponding sample in the reference cell, where inconsistency here means that the quantization intervals do not intersect;
b) the cell pair is labelled as ambiguous if there are no corresponding sample pairs that are non-zero in both the current and the reference cell; and
c) the cell pair is otherwise assigned a consistent label.

4. The method of claim 3, wherein the initial classification label for a cell pair has four possible values that identify the cell as one of: a) inconsistent; b) ambiguous; c) consistent, with a preference for using the cell of the reference block in representations of the current frame; d) and consistent, with a preference for using the cell of the current block in representations of the current frame, and wherein preference for using the reference cell or preference for using the current cell, in representations of the current frame, is determined based on information identifying which of the current and reference cells is more finely quantized.

5. The method of claim 2, wherein comparing corresponding cells is based on:
a) a distortion reduction value that assesses the maximum amount by which quantization distortion can be reduced within the more finely quantized of the cell pair, over sample locations for which the current and reference quantization intervals are consistent and both current and reference samples are non-zero;
b) a distortion enlargement value that assesses the distortion between the current and reference cells over sample locations for which the current and reference quantization intervals are inconsistent; and
c) an energy value that accumulates an energy statistic, equivalent to distortion between decoded sample values and 0, over all samples of the current and reference cells that are included in the distortion reduction and distortion enlargement value calculations;
where the cell pair is labelled inconsistent if the distortion enlargement term exceeds a specified fraction of the energy value, ambiguous if the energy value is 0; else consistent, where preference for using the reference cell or preference for using the current cell, in representations of the current frame, is determined based on a comparison between the distortion reducing and distortion enlargement values, together with information identifying which of the current and reference cells is more finely quantized.

6. The method of claim 1, wherein the code-blocks are independently coded blocks of samples from sub-bands produced by discrete wavelet transformation of the frame sample values.

7. The method of claim 1, wherein ambiguity in the classification label assigned to a cell pair is resolved with the aid of temporal inconsistency tracking information, which identifies whether or not any temporal change has been detected over the cell's region of support, in any frame following the one that is associated with the cell's reference code-block, such that the ambiguous label is adjusted to an inconsistent label if such temporal change has been detected.

8. The method of claim 7, wherein cells with a similar region of influence in the video frame, identified as co-located cells, are collected in groups and a co-inconsistency step modifies temporal inconsistency tracking information so as to identify temporal change for one cell within a group based on the detection of novel temporal inconsistency in any cell within the same group, where novel temporal inconsistency in a cell means that temporal change is detected for the first time in that cell since the frame was associated with the cell's reference code-block.

9. The method of claim 7, wherein temporal inconsistency tracking is performed by assigning a binary state variable to cells in a frame, where the binary state variable for a cell is set to a prescribed value, its active state, after temporal change is identified, and is reset to the an other value, its inactive state, when the reference buffer is updated so that future frames will employ a new reference code-block for the cell.

10. The method of claim 8, wherein temporal inconsistency tracking information is performed jointly for all of the co-located cells within a group, using a single state variable that serves to identify the most recent frame in which novel temporal inconsistency has been detected within any cell of the group.

11. The method of claim 8, wherein a co-consistency step adjusts the classification label of a cell from ambiguous to consistent, if the temporal inconsistency tracking information for the cell does not identify temporal change since the frame associated with the cell's reference code-block, and another co-located cell in the same group, whose reference code-block comes from the same or an earlier frame, is labelled as consistent.

12. The method of claim 7, where a cell belonging to a lower resolution sub-band of a frame, whose region of influence in the video frame overlaps that of a cell from a higher resolution sub-band, is identified as an ancestor of the higher resolution cell, and an inter-consistency step adjusts the classification label of the higher resolution cell from ambiguous to consistent, if the temporal inconsistency tracking information for the higher resolution cell does not identify temporal change since the frame associated with that cell's reference code-block, and the ancestor cell's reference code-block comes from the same or an earlier frame and is labelled as consistent.

13. The method of claim 12, wherein an inter-inconsistency step adjusts the temporal inconsistency tracking information for the higher resolution cell, so that it identifies temporal change in the higher resolution cell once novel temporal inconsistency has been detected in the ancestor cell.

14. The method of claim 12, wherein an inter-inconsistency step adjusts the temporal inconsistency tracking information for the higher resolution cell, so that it identifies temporal change in the higher resolution cell once novel temporal inconsistency has been detected in an ancestor cell, or in an ancestor of said ancestor cell, but not if the an immediate ancestor is ambiguous and a power inversion property is observed, meaning that a measure of signal power within the higher resolution cell's reference samples is larger than a measure of signal power within the immediate ancestor's reference samples.

15. The method of claim 14 applied to groups of co-located cells, such that a group of co-located cells from higher resolution sub-bands has an identified ancestor group, consisting of the lower resolution ancestor cells of each cell in the higher resolution group, and the measures of signal power used to identify power inversion are calculated over all cells in the higher resolution group and over all cells in the lower resolution ancestor group.

16. The method of claim 1, wherein each ambiguous cell classification label remaining ambiguous is adjusted to a non-ambiguous label, where the adjusted label is inconsistent if temporal inconsistency tracking information for the associated cell identifies temporal change, else consistent if a power inversion property has been observed in connection with the cell, else determined using a default policy that specifies either inconsistency or consistency as the default label for all cells that would otherwise remain ambiguous.

17. The method of claim 1, wherein the reference buffer is updated based on contextual hints that allow determining whether a code-block of the current video frame should be used as a reference code-block for future frames, such contextual hints including protocol information and designated marker codes that accompany the encoded video content received by the decoder.

18. The method of claim 2, wherein the reference buffer is updated based on cell classification labels, together with quantization interval length statistics, such that a current code-block that has a sufficient fraction of cells labelled as inconsistent or consistent with a preference for using the current cell in representations of the current frame, is entered into reference buffer to become a reference cell for future frames, where the sufficient fraction itself depends on the quantization interval length statistics.

19. The method of claim 1, wherein a video frame is reconstructed from merged cells of the frame, such that a merged cell is derived from the current and reference cells of a cell pair by:
a) using the decoded sample values of the current cell when the final classification label for the cell is inconsistent or when the classification label or quantization interval length statistics identify the current cell as the one that is preferred for representations of the current frame; else
b) using the decoded sample values of the reference cell.

20. The method of claim 13, where code-blocks from selected high resolution sub-bands are assigned only one cell each and that cell's final classification label is pre-determined based on the classification labels assigned to lower resolution cells, so that only a reference version or a current version of each high resolution code-block needs to be decoded, rather than both versions, depending on the pre-determined classification labels, where the high resolution cells are initially assigned ambiguous labels, and converts these ambiguous labels to final classification labels that are inconsistent or consistent, where the converted label is inconsistent if temporal inconsistency tracking information for the associated cell identifies temporal change, else consistent if a power inversion property has been observed in connection with the cell, else determined using a default policy that specifies either inconsistency or consistency as the default label for all cells that would otherwise remain ambiguous.
